(19) United States
(12) Patent Application Publication
(10) Pub. No.: US 2025/0335539 A1
(43) Pub. Date: Oct. 30, 2025

(54) HYBRID LINEAR ALGEBRA OPTICAL PROCESSING UNIT WITHOUT INTERFEROMETERS

(71) Applicant: ARAGO COMPUTING, Arcueil (FR)

(72) Inventors: Eliott Claude Michel SARREY, Maron (FR); Ambroise Marie Christophe MÜLLER, Chaville (FR); Nicolas MULLER, Eguisheim (FR)

(21) Appl. No.: 19/188,797

(22) Filed: Apr. 24, 2025

(30) Foreign Application Priority Data
Apr. 24, 2024 (FR) FR2404253

(51) Int. Cl. G06F 17/16

(52) U.S. Cl. CPC G06F 17/16

(57) ABSTRACT

Aspects of the present disclosure relate to an optical processing unit and method for performing tensor multiplication using the optical processing unit.

### CROSS-REFERENCE TO RELATED APPLICATION(S)

This application claims priority to, and the benefit of, French Patent Application No. FR 2404253, filed in the National Intellectual Property Institute (INPI) of France on Apr. 24, 2024, the entire disclosure of which is incorporated by reference herein.

### FIELD

Aspects of embodiments of the present disclosure relate to optical processing devices and methods of performing computations using optical processing devices.

### BACKGROUND

The current rate of growth for computation and energy demands for artificial intelligence (including machine learning and inference) is unsustainable. Some predict that by the end of the decade, AI data centers could consume as much as 20% to 25% of U.S. power requirements (https://www.wsj.com/tech/ai/artificial-intelligences-insatiable-energy-needs-not-sustainable-arm-ceo-says-a11218c9). After globally consuming an estimated 460 terawatt-hours (TWh) in 2022, data centers' total electricity consumption could reach more than 1,000 TWh in 2026. This demand for power is equivalent to the electricity consumption of Japan. International Energy Agency “IEA”, Electricity 2024, Analysis and Forecast to 2026, pg. 8.

Open AI prepared a report predicting that AI training far out paces the computational capacity of modern computers. Since 2012, the amount of compute used in the largest AI training runs has been increasing exponentially with a 3.4 month doubling time. By contrast, “Moore's Law” describes a 2-year doubling period. Computing in AI training has grown by more than 300,000x since 2012, a rate of increase that far exceeds Moore's Law's prediction of 7× increase over the same period. Neural Internet, Future of AI: Compute is King: $2 trillion market boom and computational revolution, Mar. 9, 2024, See also, Open AI, Research AI and Compute, May 16, 2018.

The exponential growth of floating-point operations used to train AI models since 2018, as shown in FIG. 1, provides graphical insights into the growing energy demands created by machine learning (https://ourworldindata.org/grapher/artificial-intelligence-training-computation?time=2009 Jun. 15 . . . latest).

Another wildcard lies in the expanding growth of data centers and the associated increase in energy and water consumption. Hyperscalers like Microsoft (which is reportedly contemplating a $100 billion data center project with OpenAI called “Stargate”) are starting to look at attaching new energy sources like small modular nuclear reactors to their data centers, and work is underway to find less energy-intensive alternatives to existing AI infrastructure. But pushback against these data centers has been growing everywhere from Ireland to West Virginia in recent years, and the cascading requirements of new AI models are only amplifying that resistance. See, Fortune.com, The cost of training AI could soon become too much to bear. Apr. 4, 2024.

Over time, computational resource demand for training will only increase with the accelerating demand for AI investment and computational resources required to train increasingly more complex and sophisticated AI models. Compounding these issues is the challenge to obtain advanced chips required to perform these training operations. For example, there are critical shortages of advanced chips, such as Nvidia's H100s and A100s that are essential for training. https://www.wired.com/story/nvidia-chip-shortages-leave-ai-startups-scrambling-for-computing-power/.

In addition to compute and energy demands, training AI models also comes with significant environmental impacts. In a study dated 2019, there is an environmental cost “due to the carbon footprint required by modern tensor processing hardware.” The environmental training cost for an NLP model demands 5× the CO₂ emissions typically associated with driving an automobile over its entire lifetime. Emma Strubell et. al. Energy and Policy Considerations for Deep Learning in NLP, 57^{th} Annual Meeting of ACL, Florence, Italy. (July 2019)], See also, International Energy Agency “IEA”, Electricity 2024, Analysis and Forecast to 2026.

Rapid growth of the AI market and the commensurate demand for computational resources is forcing the industry to consider new and more efficient approaches to overcome the limitations of Moore's law, reduce the environmental impacts and elevate the concentration of available AI resources being held among just a few players in the marketplace. In addition, training AI models is capital intensive. GPT-4, for example, cost more than $100 million to train and Mistral, a Paris based OpenAI competitor, raised $400 million to train their models. Many companies do not use machine learning because they cannot outsource the training for privacy reasons and it is too expensive to train models themselves. Reducing training costs with more efficient computing methods is essential for allowing more companies, academic and research institutions and others develop their own machine learning models and further democratizing AI. https://sifted.eu/articles/mistral-releases-first-ai-model, https://www.bloomberg.com/news/articles/2023-12-04/openai-rival-mistral-nears-2-billion-valuation-with-nvidia-funding?sref=gni836kR.

Tensors (e.g., vectors or matrices) play a critical component to machine learning and inference. In machine learning and inference, tensors are used to represent input values and weights that are used for connecting elements together in the neural network. In machine learning, steps called forward and backward pass or forward and backward propagation are used to train the weights by performing many gradient descent computations using linear algebra. These operations require many tensor product operations. Depending on the amount of data being used in the machine learning process, many millions or even trillions of tensor products may be needed to complete the learning process. Tensor product or multiplication is the single and most significant bottleneck operation in machine learning and inference. The more efficient this step can be performed, the faster and more energy efficient the learning process becomes. Performing tensor products with a matrix (which is a 2D tensor) of size (N, N) involves N\textcircled{ }3 operations; whereas, the other operations in neural networks involve N\hat{ }2. Since N typically ranges from 1000 to 1,000,000, it is evident that tensor products are very resource intensive.

The basic step in tensor products involves multiplying the data and weights in the neural network. FIG. 2 represents the neural network and the math of a single data point X and a single weight W to obtain an output O. This same representation can be applied with multiple data inputs X1 and X2 and weights W1 and W2. Instead of just doing only one compute, as shown in FIG. 2, there are three computations shown in FIG. 3. Due to the tensors being vectors of a dimension 2 and 2, there are only two products and one sum necessary to compute the output. FIG. 3 represents the computations for this single layer neural network.

The two neural networks described so far only have a single output. In practice, neural networks have many more outputs. By adding more outputs, more weights are needed for connecting the outputs to the inputs. If there are two outputs, the number of weights will be increased by two for a total of four, as shown in FIG. 4. The tensor products described so far are for a vector-vector multiplication FIG. 2 and for a vector-matrix multiplication FIG. 4.

Rather than trying to overcome the current compute limitations with traditional processors and electronic computing, solely by throwing more computing resources at the problem-leading to all of the issues already discussed, a different approach needs to be explored. In the past, light has proven to be very effective for digital communications. To increase the bandwidth and reduce the energy costs for communication purposes, optical fibers rather than electrical wires are being used. Optical data links have replaced copper wires for long haul communications lines and shorter spans, all the way down to rack-to-rack communications in data centers. Optical data communications are much faster and require less power. Ryan Hamerly, Future of Deep Learning Is Photonics, IEEE Spectrum (June 29, 2021). Using optics (in the form of photonic processors) to improve computational efficiency for inference also shows promise. Photonic processors have been introduced as a way to use light rather than digital processors to perform linear algebra calculations required for tensor products.

The energy demands for current processors are caused by limitations of performance when scaling the number of tensor inputs. Photonic processors do not have this limitation. As a result, photonics is uniquely well suited to satisfy AI's massive demand for computation at low cost and high efficiency (https://techhq.com/2023/05/what-is-optical-computing-explained/#:˜:text=The%20history%20of%20optical%20computing,arrays%20of%20semi conductor%20smart%20pixels.) Early attempts at using photonics to improve the efficiency of basic tensor products were developed in the 1980s. For example, see Collins U.S. Pat. No. 4,569,033. In this approach the intensity or phase of laser beams is modulated by the different cells of a SLM (spatial light modulator). The modulation that each cell applies on the beam is dependent on the electrical signal addressed. Vectors are encoded (or rows or columns of a matrix) in one-dimensional SLM cell arrays, and perform an outer product of two vectors by passing the beams through the modulators encoding each vector. See FIG. 6 (figures from Collins) and FIG. 7 (generalized spatial modular in the '80s). However, these early attempts are not suitable for larger tensor multiplication operations due to the slow refresh rate of these SLM cells. As a result, they do not operate at sufficiently high enough frequencies to satisfy today's computational requirements.

Photonics processors for tensor multiplication have been developed in an attempt to solve the computational and energy demands needed for today's AI processes. While these implementations have improved the efficiency of tensor computations, they have several key drawbacks limiting their performance and efficiency. The key operations of the current photonic processors involve multiplications and accumulations, which includes multiplying pairs of numbers in vectors and matrices and adding up the results. The common way this done today is by multiplying light beams together using Mach-Zehnder interferometers (MZIs). While the original MZI principle was developed in the 1890s, current implementations are integrated on chips. Generally, the MZI splits incoming light into two beams, each taking a different path. See, FIG. 8. The resulting two beams are then recombined as a single beam. If the two paths are identical, the output looks the same as the input. On the other hand, if one of the two beams travels farther than the other or slowed, it falls out of phase with the other beam. The intensity or amplitude of the output beam can be affected by the phase difference between the two beams. If there's no phase difference between the two beams, the intensity of the output beam is the same as the input beam. But if the phase shift is 180 degrees out of phase the two beams will interfere destructively when recombined resulting in no output. The amplitude/intensity of the output beam will be the amplitude of the input beam multiplied by the cosine of half the phase difference. By controlling the phase difference between the two beams, multiplication can be achieved. David Schneider, Lightmatter's Mars Chip Performs Neural-Network Calculations at the Speed of Light, IEEE Spectrum (Aug. 29, 2020). The value of the multiplier set by the phase difference is essentially the “weight” used in the neural network.

While MZIs are being used in forward pass or propagation, they are not well suited for machine learning purposes. The reason is that they have limited resolution and accuracy for tensor calculations. When multiple forward and back pass occur for training, so does error propagation. Training requires a very high dynamic range especially compared to inference. See Id. David Schneider. It is also difficult to scale systems using MZIs to larger matrices-they are currently limited to 64×64 matrices. Sunil Pai et. al. Experientially realized in situ backpropagation for deep learning in nanophotonic neural networks, Science, (Apr. 27, 2023) (“We measured backpropagation gradients for phase-shifter voltages by interfering forward and backward propagating light and simulated in situ backpropagation for 64-port photonic neural networks.”)

Since both the forward pass and backward pass involve a chain of matrix multiplications, error propagation using MZI in networks can cause inaccuracies in the multiplications of large matrices (significant errors for sizes larger than 64 by 64) in inference operations as well as machine learning-unacceptable error propagation occurs for large matrices for both the forward pass and for the backward pass. Thus, for matrices larger than 64 by 64 these photonic processors do not work well for inference or machine learning.

A critical need exists to improve the energy efficiency of AI computing and elevate the negative impacts discussed early for GPUs/TPUs, including the current architectures for photonic processors. Many of the limitations with current photonic processors designs stem from the use of MZIs (and similar interferometers). Examples of photonic processors with such interferometers are disclosed in US 2021/0336414 A1 Oct. 28, 2021 and Yichen Shen ET AL Deep Learning with Coherent Nanophotonic Circuits Nature Photonics, Jul. 1, 2017. A design and implementation of the photonic processor that can operate without MZIs could be used to improve the accuracy for training and inference purposes and also enable the matrix multiplications to scale significantly greater than 64 by 64 using less power and have fewer environmental impacts.

### SUMMARY

Aspects of the present disclosure relate to performing tensor multiplication operations without the need for either phase shifting or interferometers. Embodiments of the present disclosure relate to an optical processing unit and method for performing tensor multiplication. FIG. 5 graphically provides a comparison of the energy demands of current GPUs/TP Us against the energy demands of the optical processing unit (OPU) proposed by the present disclosure.

Some aspects of the present disclosure relate to an optical processing unit that performs tensor multiplication on a value of a first tensor and a value of a second tensor. The optical processing unit has a first converter configured to convert the value of the first tensor into a first electrical signal, a first logarithmic amplifier to convert the first electrical signal into a second electrical signal that represents the log of the value of the first tensor, and a first modulator and a first laser to convert the second electrical signal into a first laser beam. The optical processing unit also contains a second converter configured to convert the value of the second tensor into a third electrical signal, a second logarithmic amplifier to convert the third electrical signal into a fourth electrical signal that represents the log of the value of the second tensor, and a second modulator and a second laser to convert the fourth electrical signal into a second laser beam. Some aspects of the present disclosure also relate to an optical combiner to add the first laser beam with the second laser beam to obtain a resulting laser beam representing the log of the value of the first tensor multiplied by the value of the second tensor, or, equivalently, the log of the value of the first tensor, added to the log of the value of the second tensor.

Some aspects of the present disclosure relate to a method for optically performing tensor multiplication on a value of a first tensor and a value of a second tensor. In some embodiments, the method includes the following steps converting the value of the first tensor into a first electrical signal, processing the first electrical signal through a first logarithmic amplifier to obtain a second electrical signal that represents the log of the value of the first tensor, and modulating a first laser with the second electrical signal to produce a first laser beam. In some embodiments, the method also includes the steps converting the value of the second tensor into a third electrical signal, processing the third electrical signal through a second logarithmic amplifier to obtain a fourth electrical signal representing the log of the value of the second matrix, and modulating a second laser with the fourth electrical signal to produce a second laser beam. In some embodiments, the method may also include the step of optically combining the first laser beam and the second laser beam to obtain a resulting laser beam representing the log of the value of the first tensor multiplied by the value of the second tensor, or, equivalently, the log of the value of the first tensor added to the log of the value of the second tensor.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 depicts the growth in energy consumption in training modern machine learning models from 2012 to 2024.

FIG. 2 depicts a neural network representation of one input (x) and one weight (w) to get one output (o) and the equation representation, which equates to a scalar-scalar multiplication.

FIG. 3 depicts a single-layer neural network representation where there is two inputs (x1, x2) and two weights (w1, w2) to get one output (o) and the equation representation, which equates to a vector-vector multiplication.

FIG. 4 depicts a neural network representation of two inputs (x1, x2) and four weights (w11, w12, w13, w14) to get two outputs (o1, o2) and the equation representation which equates to a vector-matrix multiplication.

FIG. 5 compares the energy consumed for the matrix multiplication depending on the size of the matrix for the modern GPUs and TPUs compared to a photonic processor implemented according to one embodiment of the present disclosure.

FIG. 6 is an early attempt using photonics to improve vector and matrix multiplication resulting in a matrix.

FIG. 7 depicts a generalized vector-matrix multiplication utilizing a spatial modulator.

FIG. 8 shows an example of a single Mach-Zehnder Interferometer, an example of a way to control the phase difference between two light beams.

FIG. 9 is a flow chart representation detailing the steps of a scalar-scalar multiplication example according to one embodiment of the present disclosure.

FIG. 10 shows an exemplary embodiment of the components of a photonic processor for scalar-scalar multiplication used over one clock cycle.

FIG. 11 is a flow chart representation detailing the steps of a vector-vector multiplication example according to one embodiment of the present disclosure.

FIG. 12 shows an exemplary embodiment of the components of a photonic processor for a vector-vector multiplication example used one clock cycle.

FIG. 13 is a flow chart representation detailing the steps of a vector-matrix multiplication over two clock cycles according to one embodiment of the present disclosure.

FIG. 14 shows an exemplary embodiment of the components of a photonic processor for a vector-matrix multiplication over one clock cycle.

FIG. 15 depicts different representations of a vector-matrix multiplication, in the equation form, neural network per clock cycle form, and a hardware representation of the same multiplication according to one embodiment of the present disclosure.

FIG. 16 is a flow chart representation detailing the steps of the present disclosure for a matrix-matrix multiplication.

FIG. 17 shows an exemplary embodiment of the present disclosure for a matrix-matrix multiplication used over one clock cycle.

FIG. 18 depicts different representations of a matrix-matrix multiplication, in the equation form, neural network per clock cycle form, and a hardware representation of the same multiplication according to one embodiment of the present disclosure.

FIG. 19 shows a flow diagram of how signed values are accommodated in tensor-tensor multiplications in one embodiment of the present disclosure.

FIG. 20 shows a flow diagram of the multiplication of two tensors with signed values according to one embodiment of the present disclosure.

FIG. 21 shows an exemplary embodiment of the components of the present disclosure for multiplication of two tensors with signed values over one clock cycle.

FIG. 22 shows a flow diagram of the multiplication of two vectors with signed values over two clock cycles using a photonic processor according to one embodiment of the present disclosure.

FIG. 23 shows an exemplary alternative embodiment of the components of the present disclosure for multiplication of two vectors with signed values.

FIG. 24 shows a flow diagram of scalar-scalar multiplication depicted in bit representation to get a 16-bit precision result using 8-bit input precision and 8-bit readout precision at the output of the component performing scalar-scalar multiplication.

FIG. 25 shows a flow diagram of vector-vector multiplication depicted in bit representation to get a 14-bit precision result using 6-bit input precision and 8-bit readout precision at the output of the component performing vector-vector multiplication.

FIG. 26 depicts a schematic of a linear amplifier circuit.

FIG. 27 depicts a schematic of an exponential amplifier circuit.

FIG. 28 depicts a schematic of a logarithmic amplifier circuit.

FIG. 29 depicts a schematic of an integration circuit.

FIG. 30 shows the architecture of a vertical-cavity surface-emitting laser (VCSEL).

FIG. 31 depicts a non-limiting set of examples of light sources that could be used in a possible embodiment: photonic-crystal surface-emitting lasers (PCSEL), distributed feedback/edge emitting lasers (EEL), and light-emitting diodes.

FIG. 32 is a cross-sectional view depicting an embodiment of the present disclosure that includes a transmissive optical component performing a fanout function.

FIG. 33 is a cross-sectional view depicting an embodiment of the present disclosure that includes a reflective optical component performing a fanout function that reflects the light beams toward transducers on a same substrate as light sources.

FIG. 34 is a cross-sectional view depicting an embodiment of the present disclosure that includes a transmissive optical component performing a fanout function and a mirror to reflect the light beams toward transducers on a same substrate as light sources.

FIG. 35 shows a non-limiting diagram of a vector-vector multiplication.

FIG. 36 shows a non-limiting diagram of a vector-matrix multiplication.

FIG. 37 shows a non-limiting diagram of a matrix-matrix multiplication.

FIG. 38 depicts a schematic of an adder circuit.

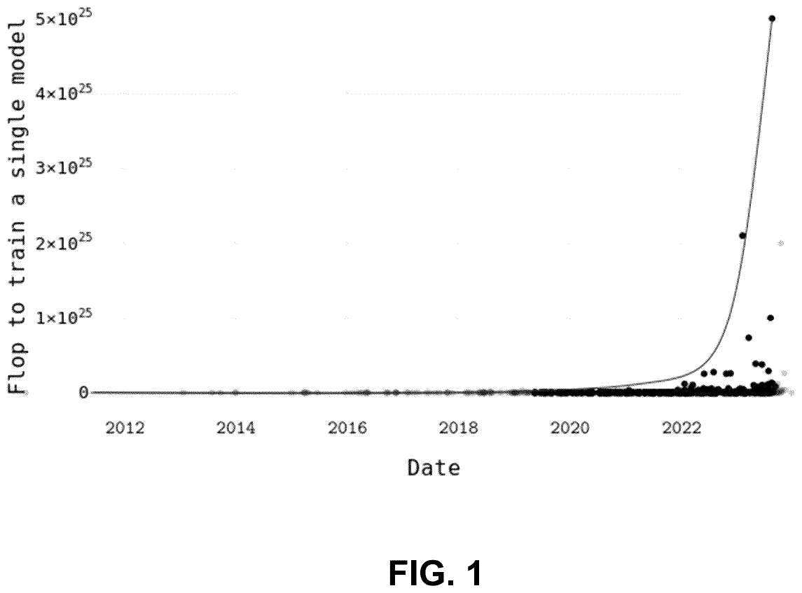

### DETAILED DESCRIPTION

### 1. Scalar-Scalar Multiplication

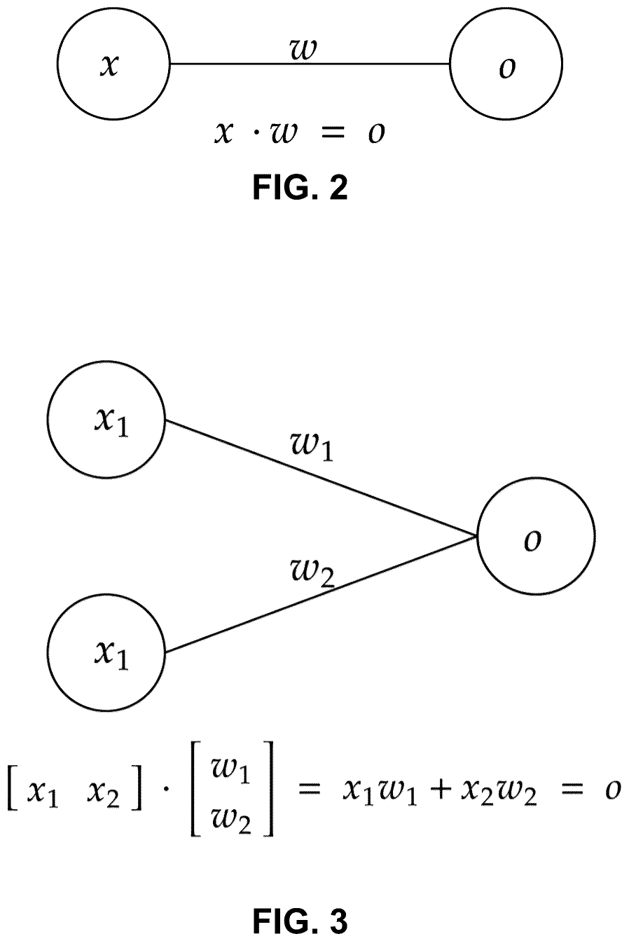

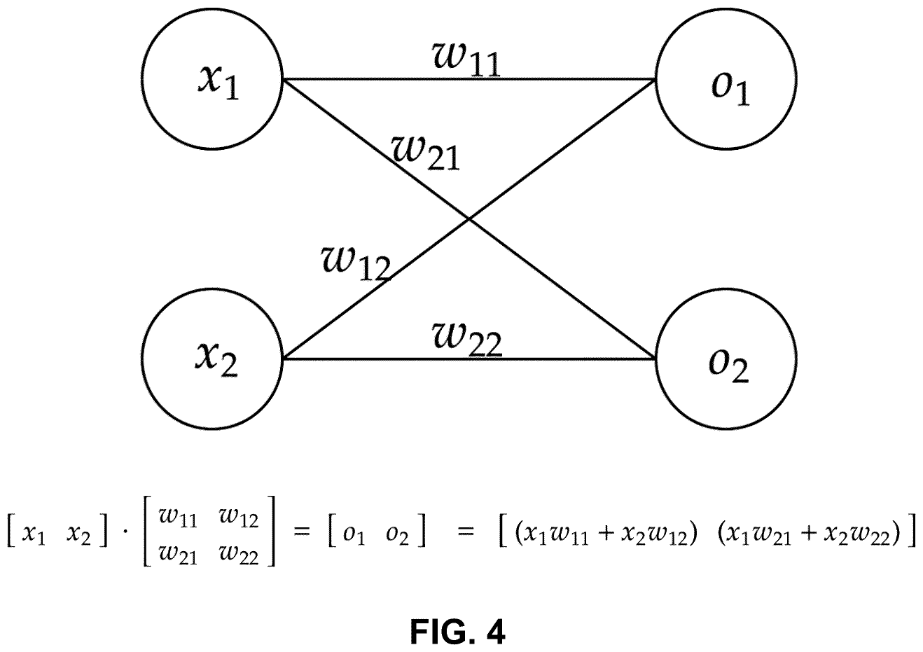

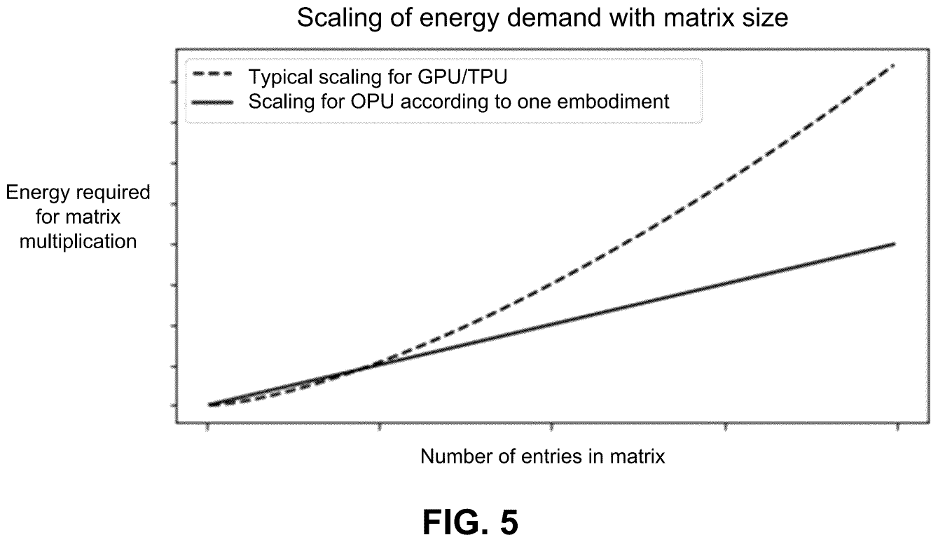

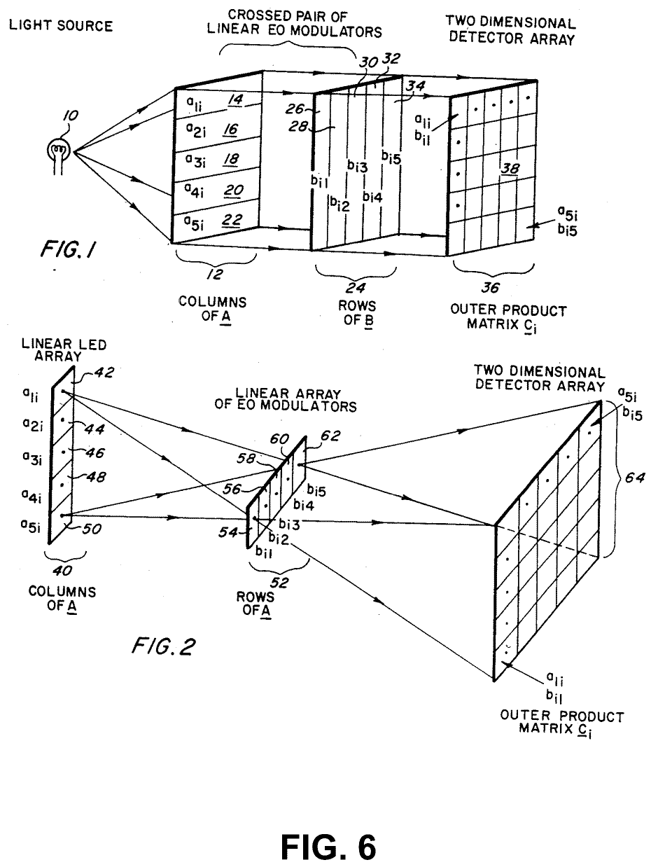

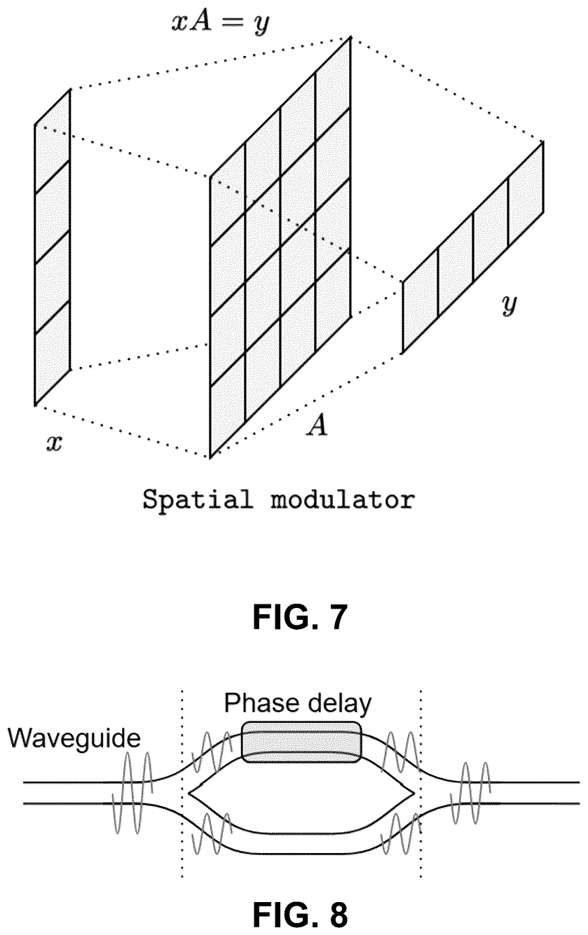

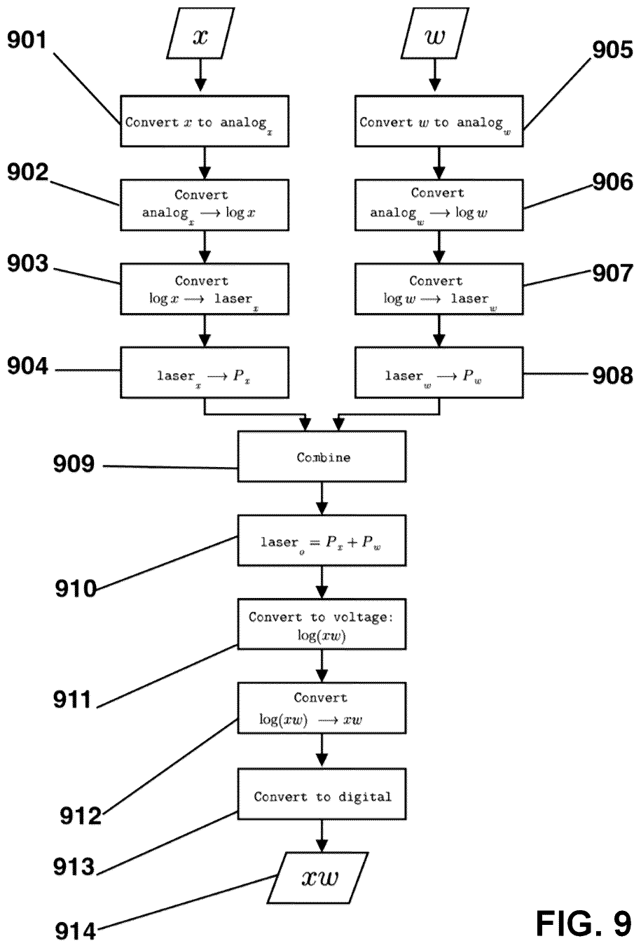

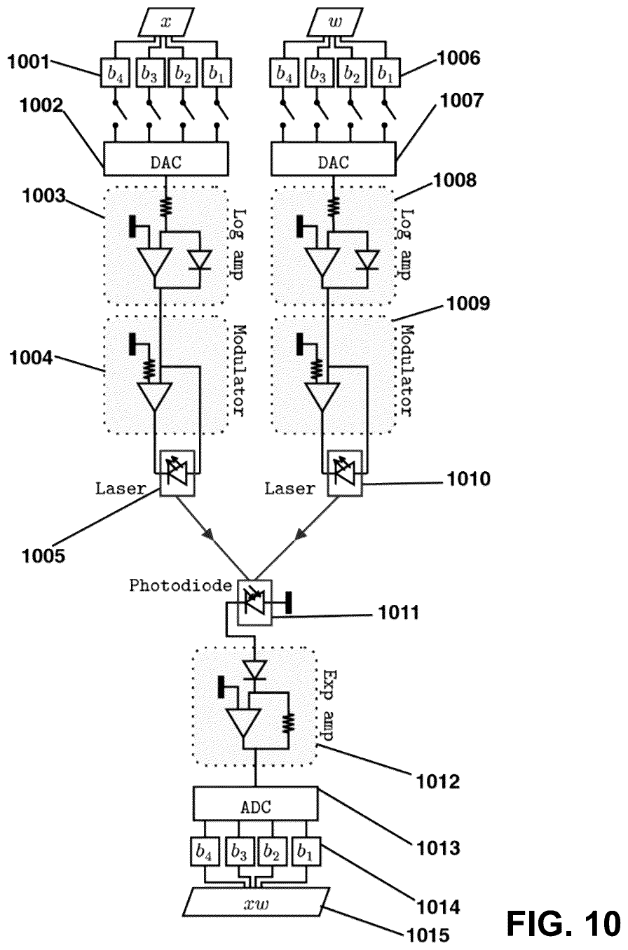

In the background section at FIG. 2, we presented the simplest neural network involving one data point and one weight or X*W=O. In FIG. 9 and FIG. 10, we show the steps for how to implement this simple neural network using embodiments of the present disclosure. FIG. 9 is a flow chart representation detailing the steps of according to one embodiment of the present disclosure and FIG. 10 depicts an exemplary embodiment including the components for implementing an embodiment of the present disclosure. In the first step 901, shown in FIG. 9, input data X (a binary number), is converted into an analog signal, analog_{X}. In FIG. 10, the exemplary implementation for performing this step 901 is with a commonly available digital to analog converter 1002 or “DAC.” In this exemplary embodiment, input weight W (a binary number) is simultaneously or concurrently converted to an analog signal analog_{W} by another DAC 1007. However, an alternative implementation could enable serial operations over one or more clock cycles for the conversion of X and W into analog signals using the same DAC. As used herein, when operations are described as being performed concurrently these operations may be performed by separate hardware components operating in parallel, where those operations may be temporally aligned (e.g., having same start and end times) or temporally offset (e.g., having different start and/or end times) and where the different operations performed by different hardware components may take differing amounts of time (e.g., different numbers of clock cycles) to complete.

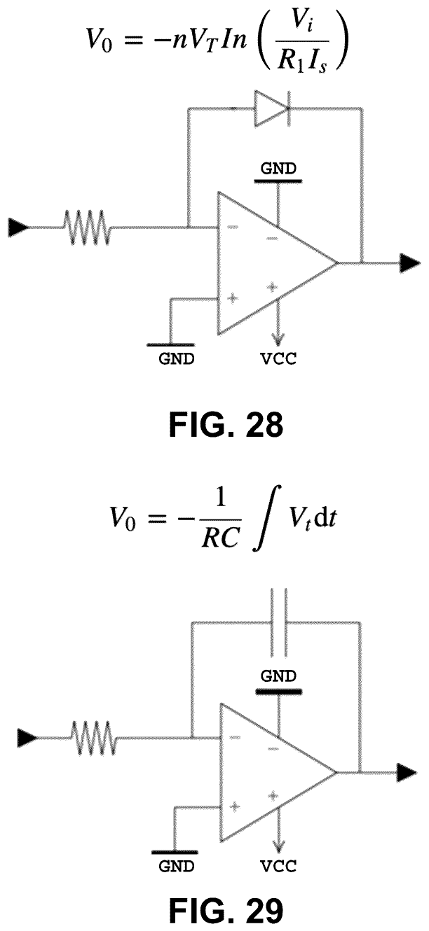

In the next steps 902 and 906 shown in FIGS. 9 & 10, the analog signals analog_{X} & analog_{W} are simultaneously or concurrently converted into log X and log W using log amplifiers 1003 and 1008. Log amplifier 1003, 1008 shown in FIG. 10 are further detailed in FIG. 28. This logarithmic amplifier can be the amplifier shown and described with respect to FIG. 28. Again, an alternative approach could be implementing serial operations over additional clock cycles using only one log amplifier.

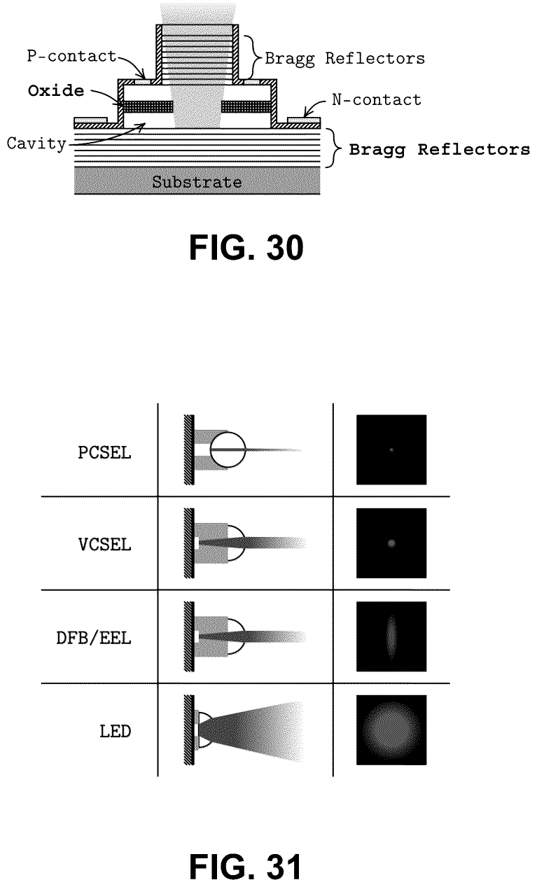

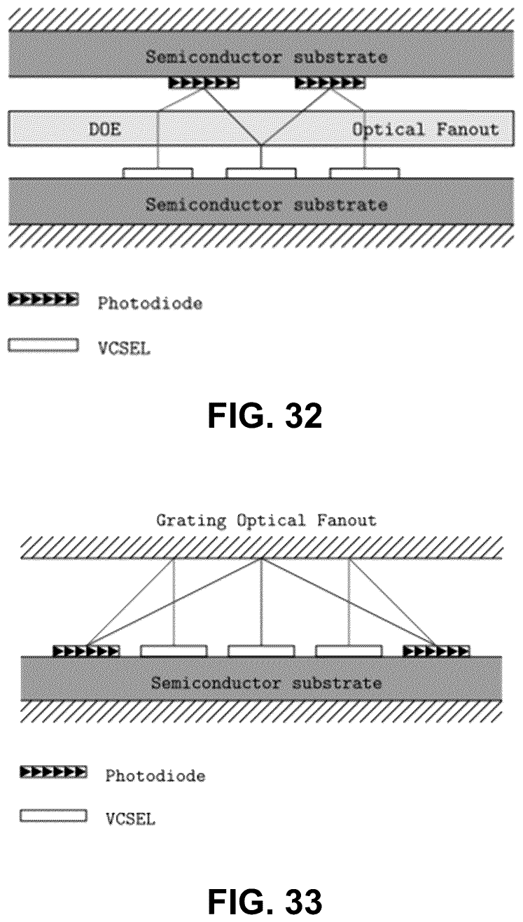

In the next steps 903 and 907 shown in FIG. 9, log X & log W are simultaneously or concurrently input into two modulators 1004 and 1009 shown in FIG. 10 to control light sources labeled laser_{X} & laser_{W}, respectively. While various embodiments of the present disclosure will be described herein in examples using lasers as the light sources, embodiments of the present disclosure are not limited thereto. In a possible embodiment, a variety of light sources or emitters that may be used include but not limited to light emitting diodes (LEDs), lasers, etc. See FIG. 30, FIG. 31 & FIG. 32 and the related discussion infra for examples of these potential light sources. As such, where the term laser is used herein, it should be understood that embodiments include alternatives using other types of light sources, such as LEDs, and where the term laser beam is used herein, embodiments include light beams that are not laser beams. In a possible embodiment, lasers are used. These lasers can be a variety of lasers, however in a possible embodiment they are vertical-cavity surface-emitting lasers or “VCSELs” as further discussed with respect to FIG. 30. The output of the laser_{X} 1005 is a laser beam having the power Pₓ 904 and the output of laser_{W} 1010 is a laser beam having the power Pw 908. However, an alternative embodiment could be implementing serial operations over one or more clock cycles using only a single modulator and a single laser.

In the next step 909 shown in FIG. 9, laser_{X} & laser_{W} are combined with one another 909. The combination results in a third laser beam having the power Pₓ+P_{w} 910 which represents the value of log X+log W or log (XW).

In the next step depicted in FIGS. 9 & 10, a photodiode 1011 is used to convert the third laser into a voltage 911. In other embodiments, other components may be used to convert the optical signal to an analog electrical signal. This voltage is then used in step 912 as the input to an antilogarithmic or exponential amplifier 1012 as shown in FIGS. 9 & 10. This antilogarithmic amplifier 1012 can be the amplifier shown and further described with respect to FIG. 27. The output is the product of X and W or XW. This output XW is an analog signal and in the next step 913 shown in FIGS. 9 & 10 this signal is converted into a digital signal using an analog digital converter 1013 or “ADC.”

### 2. Vector-Vector Multiplication

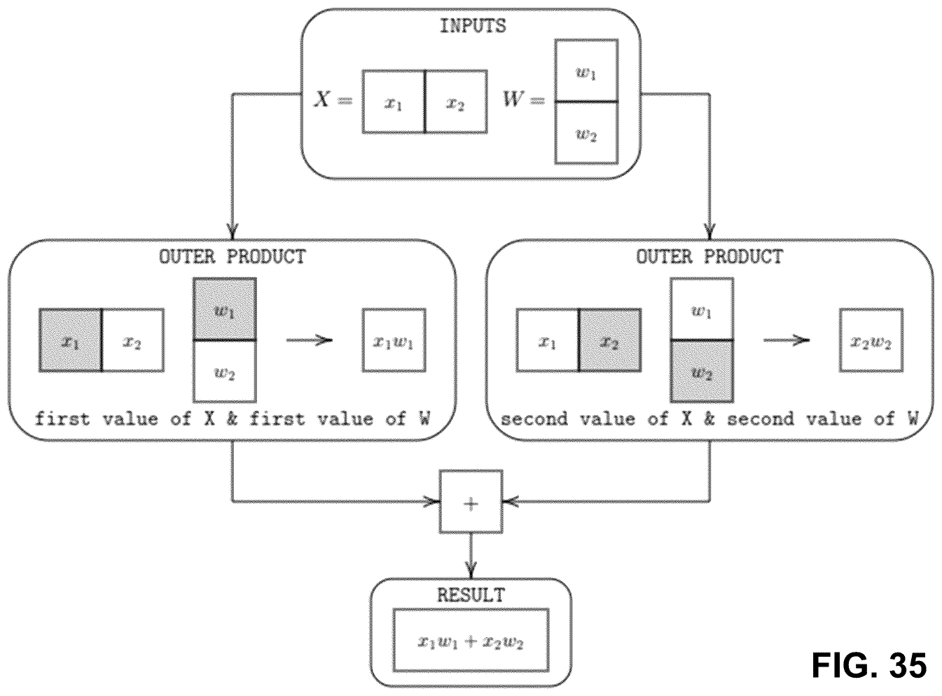

In FIG. 35 a non-limiting representative example of a vector-vector multiplication is provided.

In FIG. 3 (previously discussed in the background section), we also presented a neural network representing a vector-vector multiplication. As stated earlier, instead of just doing only one computation, as shown in FIG. 2, there are three computations shown in FIG. 3. Since the matrices are vectors of 1×2 and 2×1 sizes, the three computations for the output are two products and one sum, or X₁ W₁+X₂W₂.

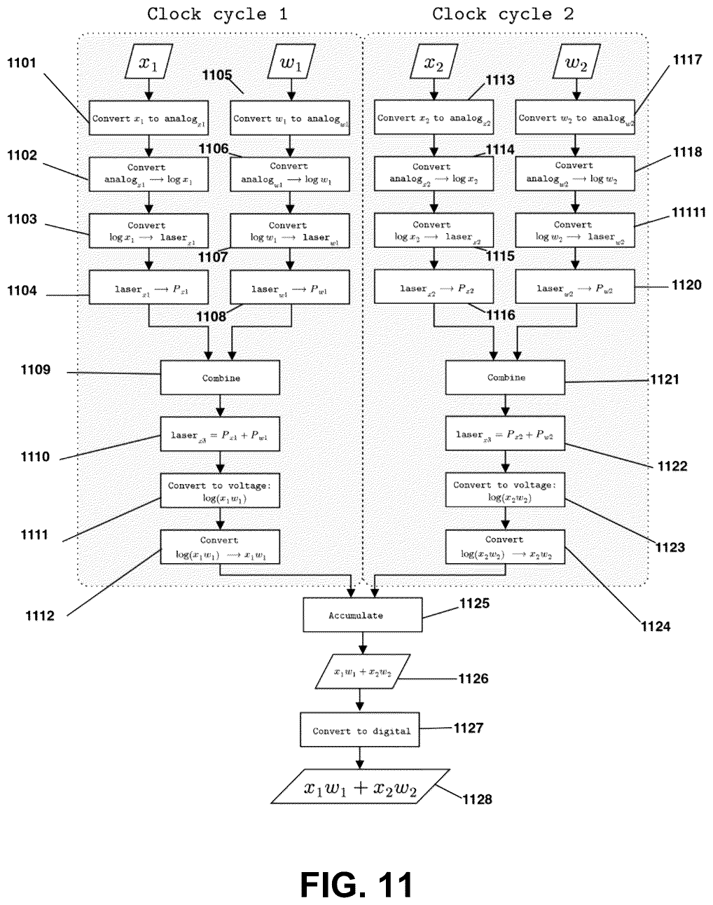

In FIGS. 11 & 12, the steps and an exemplary embodiment of the present disclosure performing a vector-vector multiplication, or

$$( \begin{matrix}{x}_{1} & {x}_{2}\end{matrix} ) \cdot ( \begin{matrix}{w}_{1} \\ {w}_{2}\end{matrix} ) = {x}_{1} \cdot {w}_{1} + {x}_{2} \cdot {w}_{2} \qquad ( 1 )$$

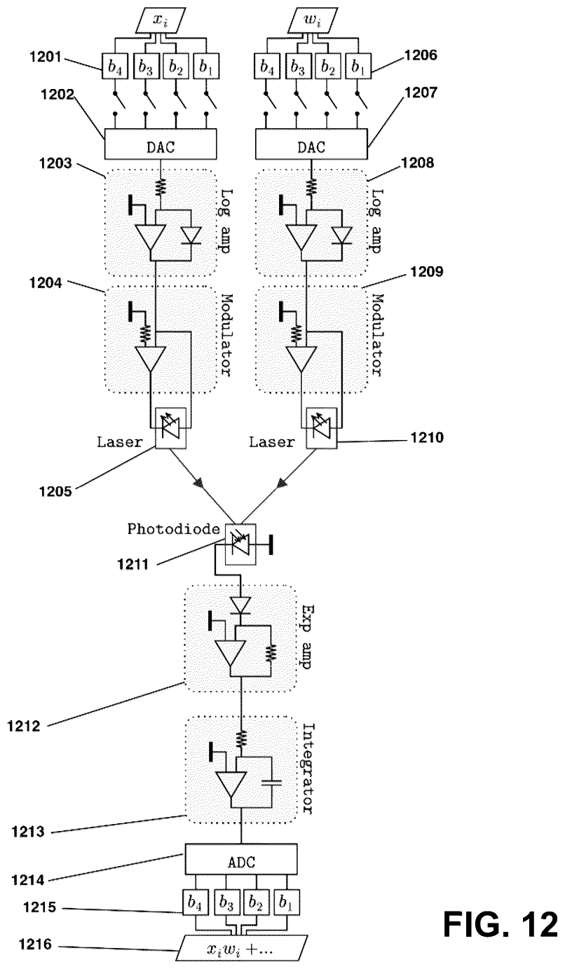

FIG. 11 shows the operational steps for multiplying the vector X₁X₂ (a first vector) with a second vector W₁ W₂. The steps performed in the shaded region, steps 1101 to 1112 and 1113 to 1124 in FIG. 11 for X₁×W₁ are the same as those described in FIG. 9 steps 901 to 914. Likewise, the components for performing the steps in FIGS. 11 (1101 to 1112 and 1113 to 1124). The only component in FIG. 12 not shown in FIG. 10 is the integrator, FIG. 12, 1213, accumulator step in FIG. 11, 1125. The operation of the accumulator/integrator will be discussed below.

In a possible embodiment, the steps for performing the X₁×W₁ multiplication as shown in FIG. 11 occur in parallel, steps 1101 to 1104 and 1105 to 1108 just as they do in FIG. 9, steps 901 to 904 and 905 to 908, as discussed earlier. These steps may occur in a single clock cycle. However, alternative embodiments could include serial operations to preserve the component count to perform these operations. See related discussion with respect to FIG. 9 & FIG. 10 concerning an alternative embodiment.

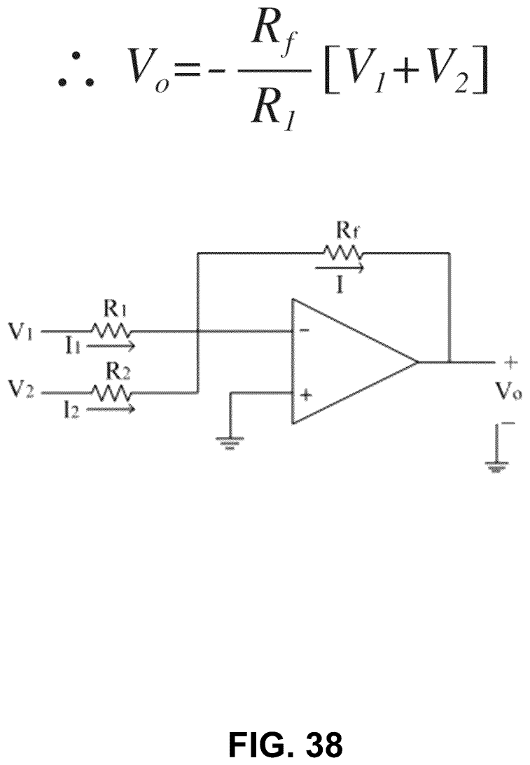

The steps for performing the operation X₂×W₂ in FIG. 11, are the same as in FIG. 9 for performing the X×W. Likewise, the components 1201 to 1212 shown in FIG. 12 for performing X₂×W₂ are the same as those shown in FIGS. 10, 1001 to 1011. In a possible embodiment, one set of components is used (as shown in FIG. 12) for performing the vector multiplications for X₁×W₁ and for X₂×W₂. These operations 1101 to 1112 may be performed serially in two clock cycles (as shown in FIG. 11) to preserve the component count (as shown in FIG. 12) so that, for example, one set of components is sufficient. Fewer components could be used if the components are further serialized as described above with respect to FIG. 10. Alternatively, two sets of the components shown in FIGS. 12, 1201 to 1212, may be used to enable parallel operations to occur in only a single clock cycle as opposed to two clock cycles for all or some of the steps shown in FIGS. 11, 1101 to 1112 and 1113 to 1124. For the parallel operations, the integrator circuits in FIG. 12, 1213 and FIG. 11, 1125 can be replaced with adder circuits, such as the one shown in FIG. 38, for single cycle operation.

Once the steps are preformed shown in FIGS. 11, 1101 to 1112 and 1113 to 1124 and components FIGS. 12, 1201 to 1212, the analog signals representing X₁W₁ (output during clock cycle 1) and X₂W₂ (output during clock cycle 2) may be added together in step 1125, FIG. 11 by an integrator shown in FIG. 12 at 1213 which accumulates the analog signals representing X₁W₁ and X₂W₂ over the two clock cycles. Integrator 1213 may be the one shown and discussed further with respect FIG. 29. The output of the integrator is an analog signal representing X₁W₁+X₂W₂ as shown at FIG. 11 step 1126. In step 1127, FIG. 11, this analog signal is converted into a digital signal representing X₁W₁+X₂W₂ by an analog to digital converter or “ADC, component 1214, FIG. 12.

### 3. Vector-Matrix Multiplication

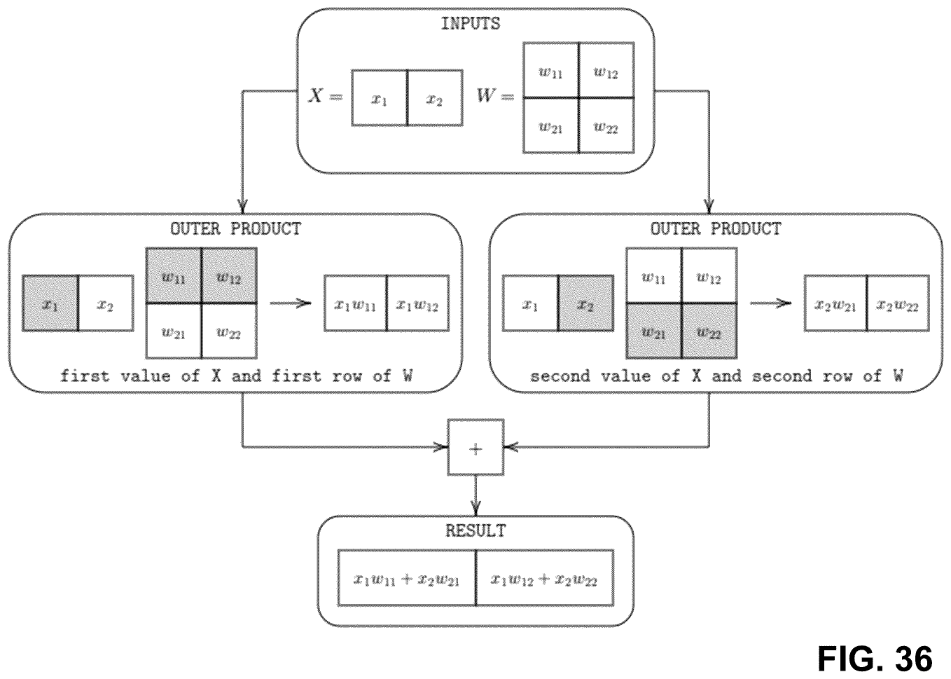

In FIG. 36 a non-limiting representative example of a vector-matrix multiplication is provided.

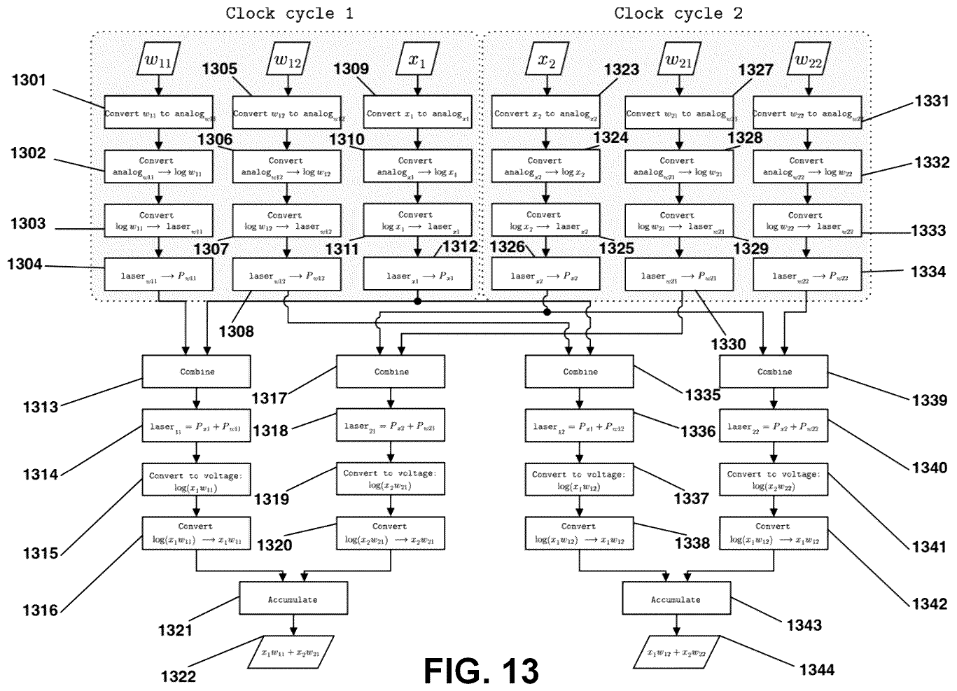

In FIG. 13, we present the steps for performing a vector-matrix multiplication, or

$$( \begin{matrix}{x}_{1} & {x}_{2}\end{matrix} ) \cdot ( \begin{matrix}{w}_{11} & {w}_{12} \\ {w}_{21} & {w}_{22}\end{matrix} ) = ( ( {x}_{1} \cdot {w}_{11} + {x}_{2} \cdot {w}_{21} ) ( {x}_{1} \cdot {w}_{12} + {x}_{2} \cdot {w}_{22} ) ) \qquad ( 2 )$$

according to one embodiment of the present disclosure. Specifically, FIG. 13 shows the operational steps for multiplying the X₁X₂ (a vector) and W₁₁ W₁₂, W₂₁ W₂₂ (a 2×2 matrix). The steps performed in the shaded region 1301 to 1312 and 1323 to 1334, FIG. 13 are substantially the same as those described in FIG. 9 & FIG. 11, steps 901 to 908 and 1101 to 1108 and 1113 to 1120.

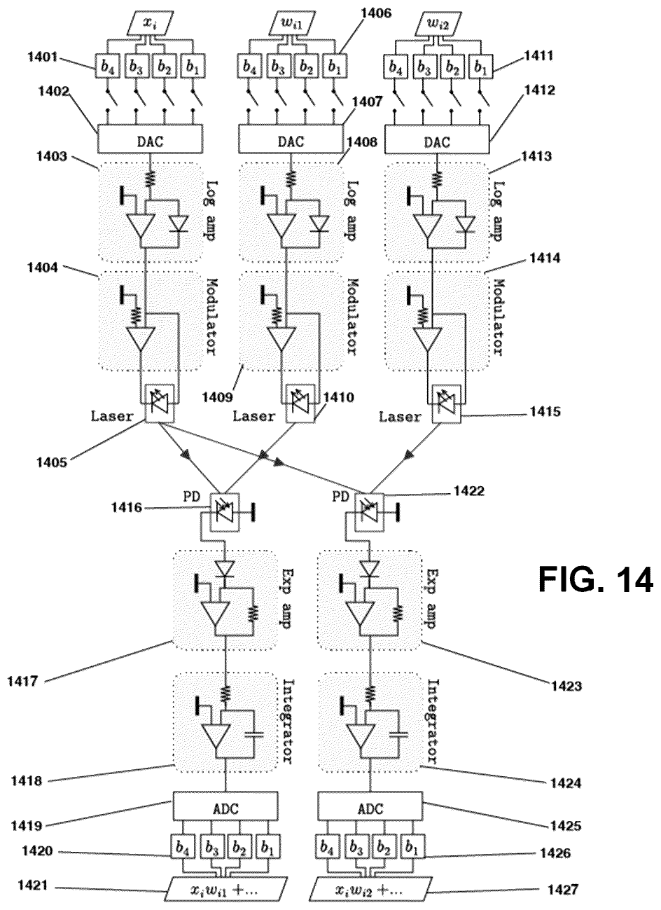

Additionally, the components for performing the shaded steps in FIGS. 13 1301 to 1312 and 1323 to 1334 are shown in FIGS. 14, 1401 to 1415. These components are also the same as those shown in FIGS. 12, 1201 to 1210.

In a possible embodiment, the steps for performing the multiplications X₁×W₁₁, X₁×W₁₂ and the multiplications X₂×W₂₁, X₂×W₂₂ multiplications as shown in the shaded area of FIGS. 13, 1301 to 1312 occur in a first clock cycle and steps 1323 to 1334 occur in a second clock cycle. As discussed earlier, these steps may occur in a single clock cycle FIG. 9 & FIG. 11, or as shown in FIG. 13, they could include serial operations to preserve the component count to perform these operations. See related discussion with respect to FIG. 9 & FIG. 11, FIG. 11 & FIG. 12 concerning the alternative embodiments. The steps for performing the shaded operations for X₁×W₁₁, X₁W₁₂ and the operations for X₂×W₂₁, X₂×W₂₂ in FIG. 13 (steps 1301 to 1312 and 1323 to 1334) are the same as in FIG. 11 for performing the X₁×W₁₁ and X₁×W₁₂, (steps 1101 to 1108 and 1113 to 1120). Likewise, the components (1401 to 1415) shown in FIG. 14 for performing the operations in the shaded area FIG. 13 are the same as those shown in FIGS. 12, 1201 to 1210. In a possible embodiment, only one set of components is used (as shown in FIG. 14) for performing the multiplications. These operations may be performed serially in two clock cycles to preserve the component count so that for example one set of components 1401 to 1415 is sufficient. Fewer components could be used if the components are further serialized as described above with respect to FIG. 10. Alternatively, two sets of the components shown in FIGS. 14, 1401 to 1415 may be used to enable parallel operations to occur in the same clock cycle for all or some of the steps 1301 to 1334. For the parallel operations, the integrator circuits in FIGS. 14, 1418 and 1424, FIGS. 13, 1321 and 1343 can be replaced with adder circuits, such as the one shown in FIG. 38, for single cycle operation.

In FIG. 14, the laser beam for laser 1405 is split into two by a fanout procedure enabled by a diffractive optical element. For examples of the diffractive optical elements and how they can be used and where they can be obtained from vendors, such as Coherent, https://www.coherent.com/optics/general-optics/diffractive-optics/splitters and Holo/Or Ltd. https://www.holoor.co.il/structured-light-doe/. While the fanout procedure or fanout optical function is shown in FIG. 14 as being implemented using a diffractive optical element or “DOE”, embodiments of the present disclosure are not limited thereto. In this disclosure, other optical components that implement a fanout procedure or optical function can be substituted for the diffractive optical element. Examples of such other optical components include a grating, a beam splitter, and/or a metalens designed to implement a fanout function.

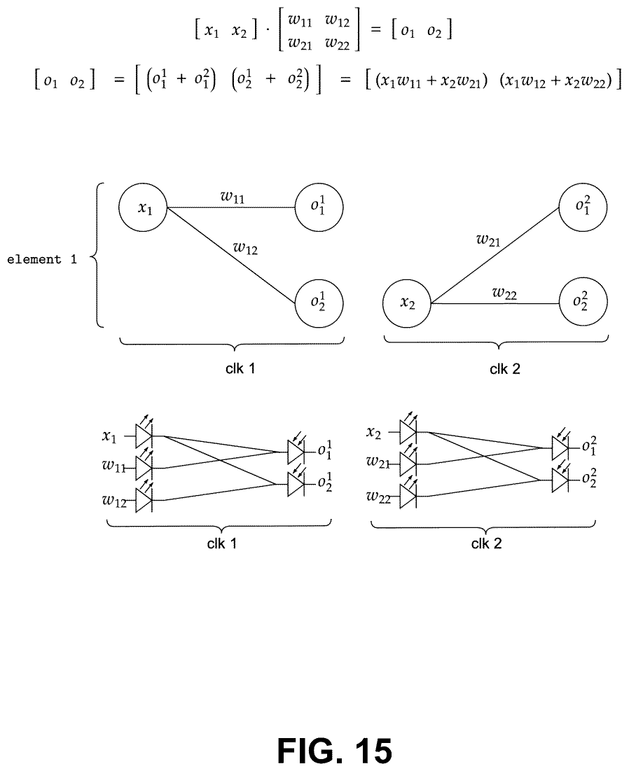

Further parallelism for the multiplication operations performed in FIG. 14 can be achieved. This can be generalized to a matrix with more than two columns. In this case the laser beam for laser X₁ in FIG. 14 is split by the diffractive optical element into N laser beams, where N is the number of columns in the matrix. In FIG. 15, clock cycle 1, for example shows the parallel operations being performed to obtain X₁×W₁₁ and X₁ W₁₂. In the next clock cycle, parallel operations can be performed to obtain X₂×W₂₁ and X₂×W₂₂.

An alternative embodiment can include no fanout, and instead add additional components to encode the value of the vector into a plurality of additional lasers. This approach would increase the number of logarithmic amplifiers, modulators and lasers to four sets rather than three as shown in this example.

Once the steps are performed as shown in FIGS. 13, 1313 to 1320 and 1335 to 1342 with components FIGS. 14, 1416 & 1417, and 1422 & 1423, the analog signals representing X₁W₁₁ and X₂ W₂₁, X₁ W₁₂ and X₂ W₂₂ may be added together in steps 1321 & 1322, and 1343 & 1344 in FIG. 13 respectively by integrators shown in FIG. 14 at 1418 & 1424. The integrator, 1424, is the same one as in FIG. 12, 1213 and as further discussed with respect FIG. 29. The output of the integrator is an analog signal representing X₁ W₁₁+X₂W₂₁ as shown at FIG. 13. This analog signal is then converted into a digital signal representing X₁ W₁₁+X₂ W₂₁ by an analog to digital converter or “ADC” shown at components 1419 and 1425 in FIG. 14. In the same way as performed for X₁ W₁₁, X₂ W₂₁, the analog signals representing X₁ W₁₂ and X₂ W₂₂ may be added together and the output converted into a digital signal to obtain X₁ W₁₂+X₂ W₂₂.

This process and the components may be scaled accordingly for any vector of greater than 2 entries and any matrix of greater than two rows. Generally, the number of times K that the steps are performed in the grayed area in FIG. 13 is either the number of entries in the vector or the number of rows in the matrix. This means that in a possible embodiment the number of clock cycles used to implement the vector-matrix multiplication is dependent on the number entries in the vector or rows in the matrix. Alternatively, all the operations can be performed in parallel during the same clock cycle by using K sets of components.

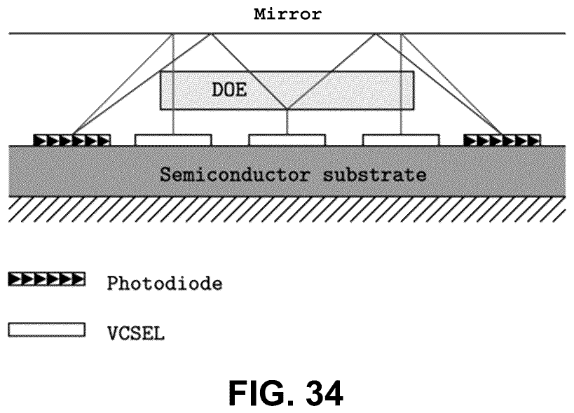

With reference to FIG. 32, in some embodiments of the present disclosure the laser FIG. 14, 1405, diffractive optical elements and the photodiodes FIGS. 14, 1416 & 1422 are stacked vertically, in a direction perpendicular to the supporting plane, such that the laser or emitters are on the lower level and the photodiodes or transducers are on the upper level, or vice versa. With reference to FIG. 33 and FIG. 34, in other embodiments, the diffractive optical elements are reflective or are combined with reflective optical elements, such that the optical signals are reflected. A diffraction grating may be used to this effect. In such embodiments the lasers and photodiodes are integrated onto the same plane.

### 4. Matrix-Matrix Multiplication

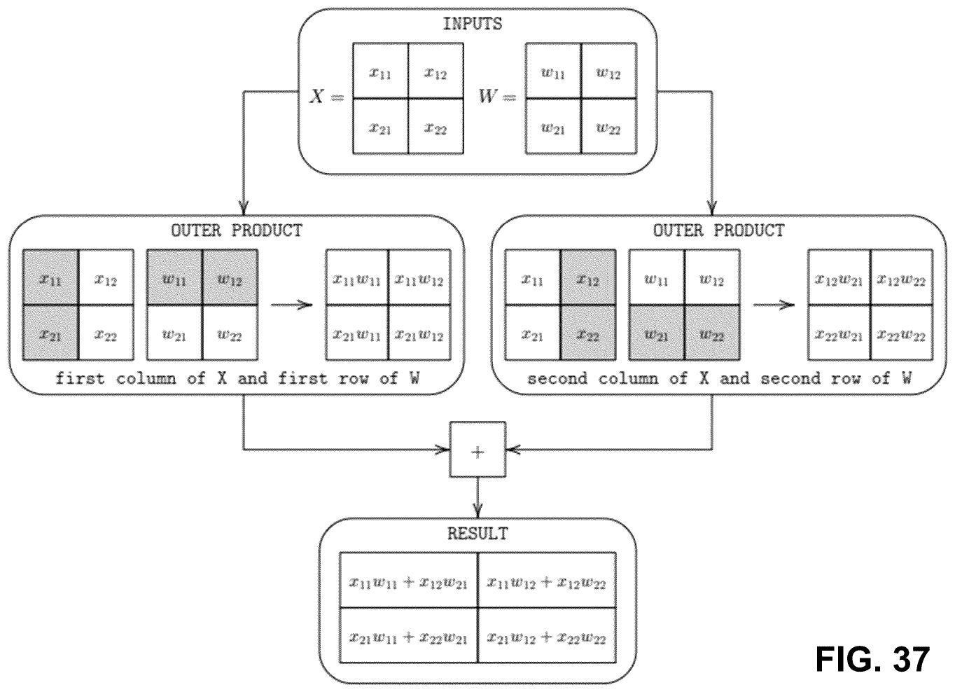

In FIG. 37 a non-limiting representative example of a matrix-matrix multiplication is provided. The exemplary approach followed for matrix-matrix multiplication is called outer product decomposition. As shown in FIG. 37, the product of two matrices X & W can be written as the sum of the outer products of the columns of the first matrix with the rows of the second matrix.

An outer product decomposition is a linear algebra operation which takes in two vectors (a first vector from the first matrix and a second vector from the second matrix) and outputs a matrix, where the components of the matrix are the products of two elements, each such pair of elements containing one value from the first vector and one value from the second vector.

As shown in FIG. 37, every value in the first vector needs to be multiplied with every value in the second vector and vice versa, such that the output matrix contains all possible combinations of an element of the first vector and an element of the second vector.

In practice this is done with a so-called “double fanout,” where every value of the first vector is fanned out to every value of the second vector, and every value of the second vector is fanned out to every value of the first vector.

The matrices resulting from the outer products are added by accumulating values as shown in FIG. 37 (one accumulation for every entry in the output matrix).

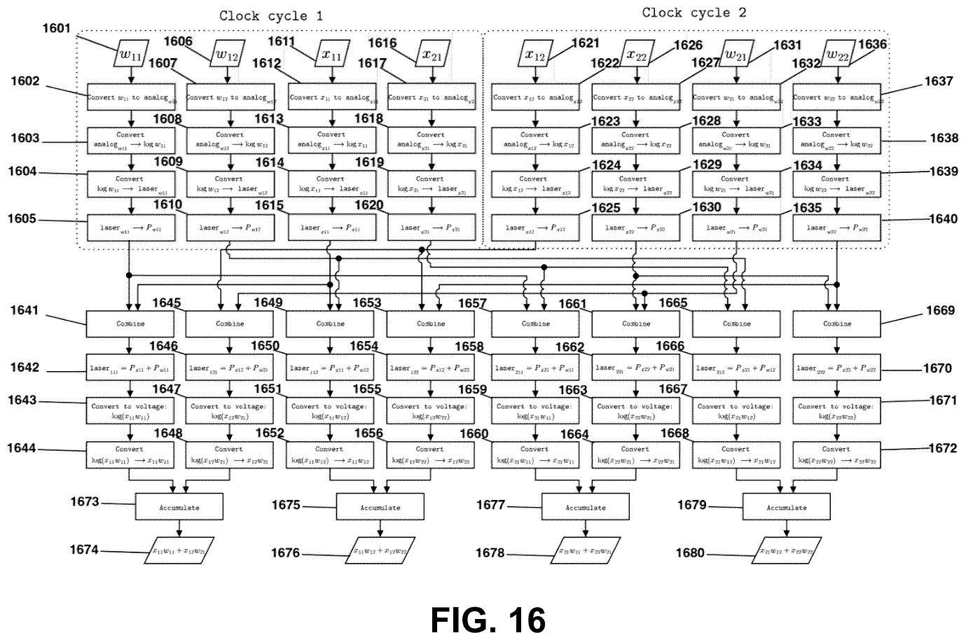

In FIG. 16, the steps are shown for performing a matrix-matrix multiplication, or

$$( \begin{matrix}{x}_{11} & {x}_{12} \\ {x}_{21} & {x}_{22}\end{matrix} ) \cdot ( \begin{matrix}{w}_{11} & {w}_{12} \\ {w}_{21} & {w}_{22}\end{matrix} ) = ( \begin{matrix}( {x}_{11} \cdot {w}_{11} + {x}_{12} \cdot {w}_{21} ) & ( {x}_{11} \cdot {w}_{12} + {x}_{12} \cdot {w}_{22} ) \\ ( {x}_{21} \cdot {w}_{11} + {x}_{22} \cdot {w}_{21} ) & ( {x}_{21} \cdot {w}_{12} + {x}_{22} \cdot {w}_{22} )\end{matrix} ) \qquad ( 3 )$$

according to one embodiment of the present disclosure. Specifically, FIG. 16 shows the operational steps for multiplying together ((X₁₁X₁₂), (X₂₁X₂₂)) (a first 2×2 matrix) and ((W₁₁ W₁₂), (W₂₁ W₂₂)) (a second 2×2 matrix). The steps performed in the shaded region steps 1601 to 1640, FIG. 16 are the same as those described in FIG. 9, FIG. 11 & FIG. 13 steps 901 to 908, 1101 to 1108 and 1113 to 1120, 1301 to 1312 and 1323 to 1334.

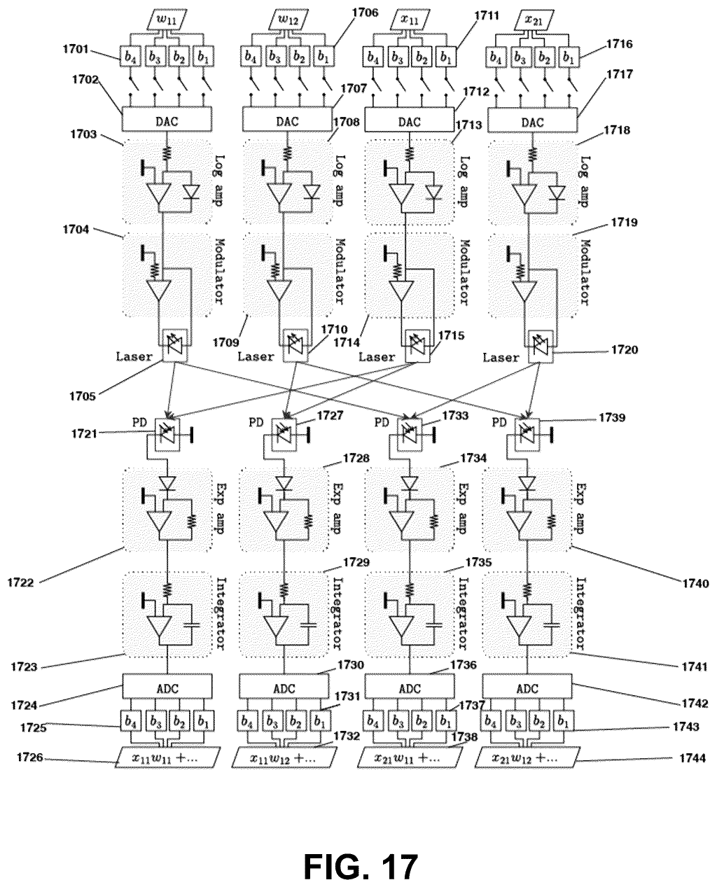

Likewise, the components for performing the shaded steps in FIG. 16 steps 1601 to 1640 are shown in FIGS. 17, 1701 to 1720 are also the same as those shown in FIG. 12 and FIGS. 14, 1201 to 1210 and 1401 to 1415.

In a possible embodiment, the steps for performing the multiplications X₁₁×W₁₁, X₁₁×W₁₂, X₂₁×W₁₁, X₂₁×W₁₂ and the multiplications X₁₂×W₂₁, X₁₂×W₂₂, X₂₂×W₂₁, X₂₂×W₂₂ as shown in the shaded area of FIGS. 16, 1601 to 1620 occur in parallel steps 1621 to 1640, just as they do in FIG. 9, FIG. 11 & FIG. 13, discussed earlier. These steps may occur in a single clock cycle, or as shown in FIG. 16, they could include serial operations to preserve the component count to perform these operations. See related discussion with respect to FIG. 9 & FIG. 10, FIG. 11 & FIG. 12, FIG. 13 & FIG. 14 concerning the alternative embodiments.

The steps for performing the shaded operations for X₁₁×W₁₁, X₁₁×W₁₂, X₂₁×W₁₁, X₂₁×W₁₂ and the operations for X₁₂×W₂₁, X₁₂×W₂₂, X₂₂×W₂₁, X₂₂×W₂₂ in FIG. 16 steps 1601 to 1620 are the same as in FIG. 13 for performing the X₁×W₁₁ and X₁×W₁₂, steps 1301 to 1312. Likewise, the components shown in FIG. 17 for performing the operations in the shaded area FIG. 16 are the same as those shown in FIGS. 14, 1401 to 1415. In a possible embodiment, only one set of components is used (as shown in FIG. 17) for performing the multiplications. These operations may be performed serially in two clock cycles to preserve the component count so that, for example, one set of components 1401 to 1405 is sufficient. Fewer components could be used if the components are further serialized as described above with respect to FIG. 10. Alternatively, two sets of the components shown in FIGS. 17, 1701 to 1720 may be used to enable parallel operations to occur in the same clock cycle for all or some of the steps 1721 to 1740. For the parallel operations, the integrator circuits in FIGS. 17, 1723, 1729, 1735 and 1741 can be replaced with adder circuits, such as the one shown in FIG. 38, for single cycle operation.

In FIG. 17, the light sources or emitters are lasers that produce laser beams that are split into two beams by a fanout procedure enabled by a diffractive optical element discussed earlier. The fanout on the two lasers can be obtained using separate diffractive optical elements or by using a common diffractive optical element. Similarly, the laser beams for lasers W₁₁ and W₁₂ are split in two using a common diffractive optical element or separate elements for each laser beam.

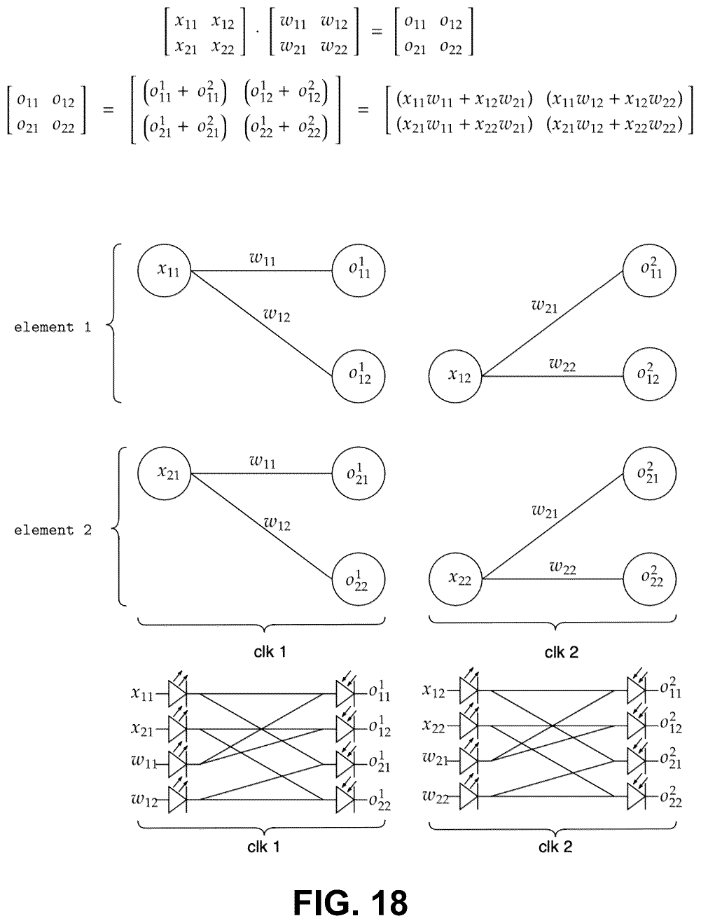

The steps are generalized for matrices with sizes larger than two. In such cases, the laser beams corresponding to the values in the columns of the first matrix (in FIG. 16 values X₁₁ and X₂₁) are each split into N laser beams using diffractive optical elements, where N is the number of columns in the second matrix. See FIG. 18 for lasers and a fanout, producing N=2 laser beams for each of the values X₁₁ and X₂₁ in a first clock cycle, and X₁₂ and X₂₂ in a second clock cycle. This can be done using one or more common optical elements shared by multiple laser beams (e.g., one common optical element shared by all laser beams or k different optical elements shared by N/k laser beams where k is a natural number, as well as embodiments where different optical elements interact with different numbers of laser beams or light beams) or separate optical elements for every laser beam. In a similar way the laser beams corresponding to the values corresponding to the values in the rows of the second matrix (in FIG. 16 values W₁₁ and W₁₂) are split into M laser beams using different diffractive optical elements, where M is the number of rows in the first matrix. See FIG. 18 for lasers and a fanout producing M=2 laser beams for each of the values W₁₁ and W₁₂ in a first clock cycle, and W₂₁ and W₂₂ in a second clock cycle. Once again, this fanout can be achieved via either a common diffractive optical element or separate elements for each beam. Details about the diffractive optical elements are the same as those discussed earlier. The effect of this fanout is to produce an outer product of a column of the first matrix with a row of the second matrix, thereby combining all possible pairs of beams encoding a value from the column of the first matrix and a value from the row of the second matrix.

In FIG. 18 bottom portion, clock cycle 1 shows the parallel operations performed to obtain X₁×W₁₁ and X₁₁ W₁₂ for the first batch element and X₂₁×W₁₁ and X₂₁×W₁₂ for the second batch element. In the next clock cycle, clock cycle 2, parallel operations can be performed to obtain X₁₂×W₂₁ and X₁₂×W₂₂ for the first batch element, and X₂₂×W₂₁ and X₂₂×W₂₂ for the second batch element. An alternative embodiment may be to include no fanout, and instead add additional components to encode the values of the matrices into a plurality of additional lasers. This approach would increase the number of logarithmic amplifiers, modulators and lasers to eight sets rather than four in this example.

Once the steps are performed as shown in FIGS. 16, 1601 to 1640 with components FIGS. 17, 1701 to 1740, the analog signals representing X₁₁ W₁₁ and X₁₂ W₂₁ may be added together in step 1673 FIG. 16 by an integrator 1723 shown in FIG. 17. An embodiment of an integrator is shown by an example and discussed further with respect FIG. 29. The output of the integrator is, for this example, an analog signal representing X₁₁ W₁₁+X₁₂W₂₁ as shown at FIG. 16 step 1674. In FIG. 17, this analog signal is converted into a digital signal representing X₁₁ W₁₁+X₁₂W₂₁ by an analog to digital converter or “ADC” shown at component 1724, FIG. 17. In the same way, the analog signal representing X₁₁ W₁₂+X₁₂ W₂₂ is also converted by an ADC 1730. The analog signals representing X₂₁W₁₁ and X₂₂W₂₁ and the analog signals representing X₂₁ W₁₂ and X₂₂ W₂₂ may be added together and their outputs converted into digital signals as shown FIGS. 17, 1738 and 1744.

This is process and the components may be generalized for larger matrices where the number of columns in the first matrix and the number of rows in the second matrix is larger than two. The number of times the steps shown in the grayed area in FIG. 16 is performed (K) is either the number of columns in the first matrix, or the number of rows in the second matrix. This means that the number of clock cycles to implement matrix-matrix multiplications is equal to K. Alternatively, all operations can be performed in the same clock cycle by using K sets of the same components in parallel.

As in the implementation of vector-matrix multiplication according to some aspects of embodiments of the present disclosure, several geometries are to be considered. With reference to FIG. 32 and FIG. 33, we may use transmissive or reflective optical elements. With reference to FIG. 32, in some embodiments of the present disclosure the lasers FIGS. 17, 1705, 1710, 1715 & 1720, diffractive optical elements and the photodiodes FIGS. 17, 1721, 1727, 1733 & 1739 are stacked vertically, in a direction perpendicular to the supporting plane, such that the laser or emitters are on the lower level and the photodiodes or transducers are on the upper level, or vice versa. With reference to FIG. 33, in other embodiments, the diffractive optical elements are reflective or are combined with reflective optical elements, such that the optical signals are reflected. A diffraction grating may be used to this effect. In such embodiments, the lasers and photodiodes are integrated onto the same plane.

### 5. Negative Sign Implementations

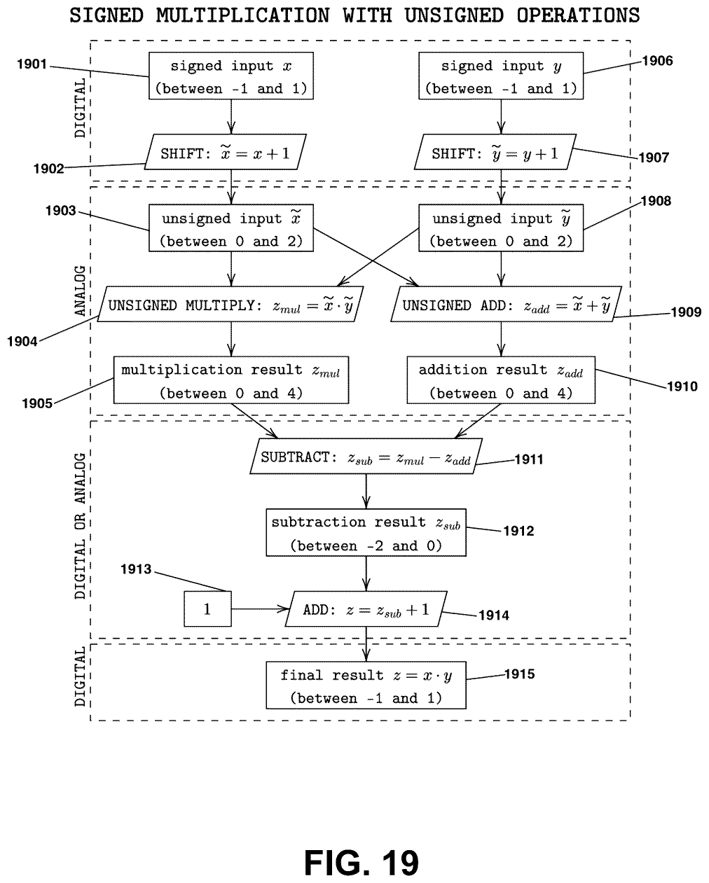

FIG. 19, shows a flow diagram depicting how negative values are accommodated in tensor-tensor multiplications according to some aspects of embodiments of the present disclosure. Since some machine learning algorithms for training and inference use of data values that can take on both positive and negative values, being able to accommodate a diverse range of model parameters and values is required to support such machine learning algorithms.

Encoding negative values with laser beam intensities is not practical because intensity measurements are inherently positive. To accommodate negative data values ranging from −1 to 1 (as an example) using optical intensity, these values are first adjusted to a new range starting from 0 and going up to 2 in a possible embodiment. This adjusted range is then scaled further to match the maximum possible intensity level, referred to as the “maximum intensity.” This maximum intensity may be determined based on tradeoffs such as energy consumption, heat dissipation, and dynamic range of the optical devices, such as non-linearities in the behaviors of the light sources (e.g., laser sources or light emitting diodes), the behaviors of the amplifiers (e.g., the input and output ranges for which the amplifiers exhibit log and antilog behavior), and saturation of the photodiodes.

Given that all values processed optically can only be positive, the analog hardware discussed earlier herein according to some embodiments of the present disclosure carries out what is known as unsigned multiplications. Stated differently, this means that in a possible embodiment according to the above disclosure, the multiplication hardware only handles positive numbers.

In an embodiment of the disclosure, if the inputs 1901 and 1906, x and y, are within a range of −1 to 1, they are adjusted to positive values by adding 1 to each, 1902 and 1907. The product of x and y is then derived by first calculating the product of the adjusted values and then subtracting the sum of the adjusted values from the product, and finally adding 1 to this result. See steps 1904, 1905, 1909, 1910, 1911, 1912, 1914 in FIG. 19.

The steps of FIG. 19 are given assuming that the possible value range of the inputs x and y is between −1 and 1. However, this is arbitrary and admits a straightforward generalization. If input x has value in the range of −Vₘₐₓ to Vₘₐₓ and input y has value in the range of −Vₘₐₓ to Vₘₐₓ, then the adjusted values are obtained by adding Vₘₐₓ to x and to y respectively. Further generalizations (e.g. where the ranges for x and y are different) may also apply in other circumstances.

To expand this to tensor multiplication with vectors and matrices containing multiple values each within the range of −1 to 1, each value is similarly adjusted by adding 1. The dot product of these vectors is then found by performing the following operations. First calculating the product of the adjusted values, subtracting the sum of the adjusted values from this product, and adding 1 to the end result. See steps 1904, 1905, 1909, 1910, 1911, 1912, 1914 FIG. 19. These operations maybe performed either before or after the sum performed by the integrators 1213, FIGS. 12, 1418 & 1424 FIGS. 14, 1723, 1729, 1735 & 1741, FIGS. 17, and 2316 FIG. 23 in the case of vector-vector, vector-matrix or matrix-matrix multiplications. In an embodiment in which the implementation is digital, these operations are performed directly on the accumulated sums, where the sums are first converted to digital using one or more analog-to-digital converters. In other embodiments where the implementation is analog, these operations may be performed either on the analog signals representing the accumulated sums or on the product of adjusted values and sum of adjusted values prior to the integrator. In the latter embodiment where the operations are performed prior to the integrator, a plurality of implementations are possible, which are discussed below.

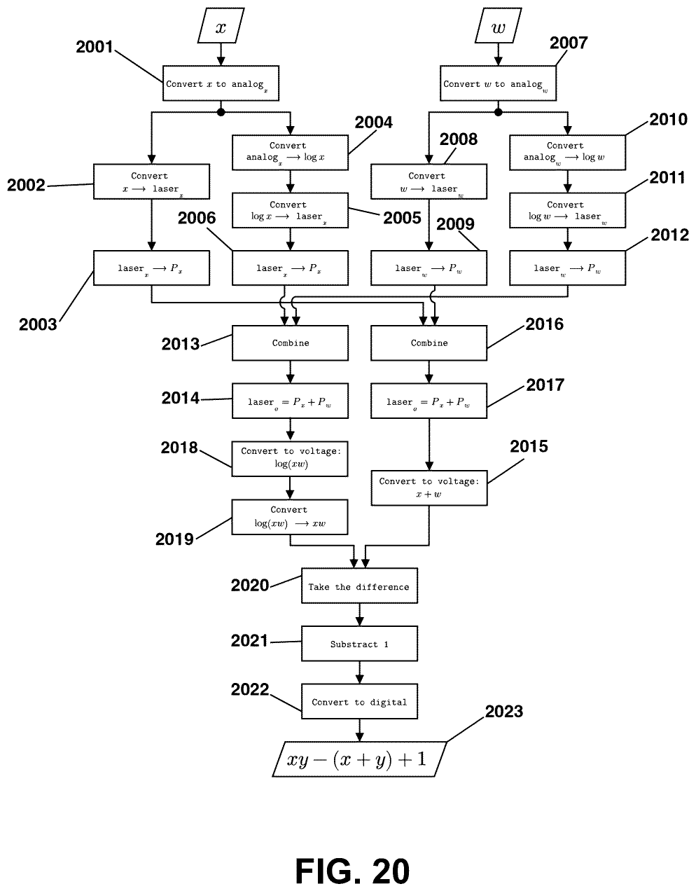

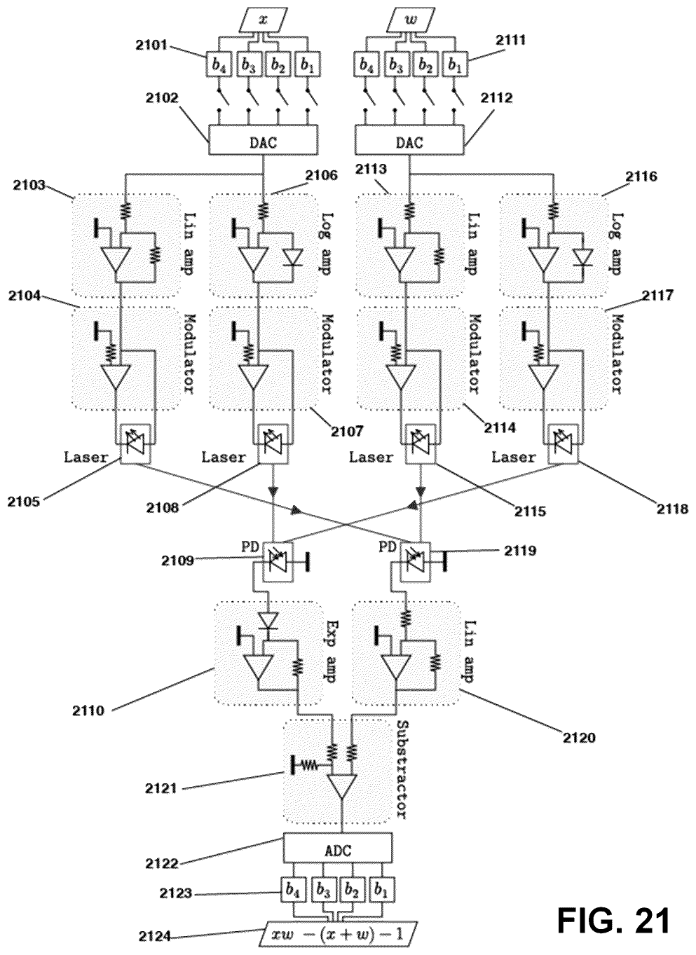

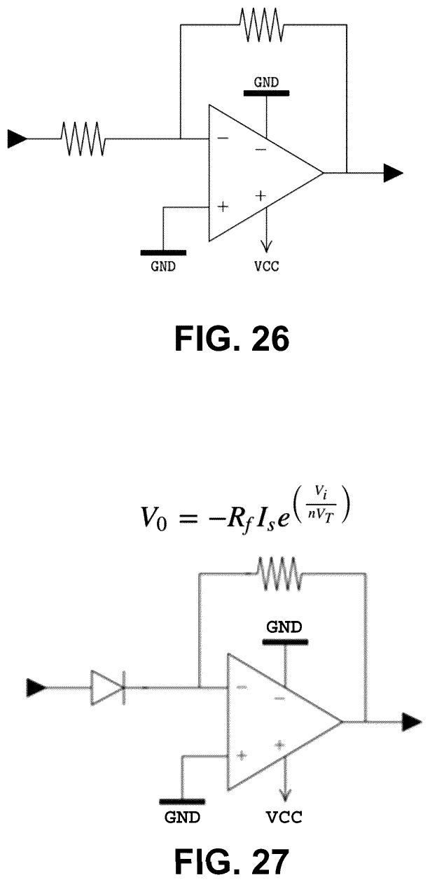

An embodiment of the present disclosure enabling the multiplication of two tensors with signed values according to the process detailed above, and where the operations specific to signed multiplication are performed in the analog domain prior to the integrator, includes two sets of amplifiers, modulators and lasers. FIG. 20 shows a flow diagram of the operations according to one embodiment of the present disclosure following this approach and FIG. 21 shows the component implementation according to one embodiment of the present disclosure following this approach. The amplifiers 2106, 2116 FIG. 21 of one set of components include logarithmic amplifiers, while the amplifiers 2103, 2113 FIG. 21 of the other set include linear amplifiers. Linear amplifiers convert an analog signal into another analog signal, where the relation between the input and output signals is linear, with positive or negative proportionality coefficient, with or without an offset value, for an appropriate range of the input signal value. A typical linear amplifier is further discussed and shown with respect to FIG. 26. In an alternative embodiment, a linear amplifier may be omitted (e.g., replaced by a wire or conductive trace) in a well-calibrated implementation.

In other aspects of the present disclosure, the steps 2001 to 2019 of FIG. 20 are similar to those described in FIG. 9, FIG. 11, FIG. 13 and FIG. 16. The analog signals resulting from the measurement of the combined beams including the laser beams originating from the first and second set of components are channeled respectively and in parallel into an exponential amplifier (steps 2015 & 2019, FIG. 20) and (component 2110, FIG. 21) and a linear amplifier (2120, FIG. 21). The two analog signals are then provided as inputs to an analog subtractor (2121, FIG. 21, step 2020, FIG. 20), the effect of which is to produce another analog signal representing the subtraction of the sum of the input tensor values from the product of the input tensor values. Adding a constant (e.g. 1) is also performed within this component, such that the resulting signal encodes the signed multiplication result. In other aspects the steps 2001 to 2019 of FIG. 20 are similar to those described in FIG. 9, FIG. 11, FIG. 13 and FIG. 16.

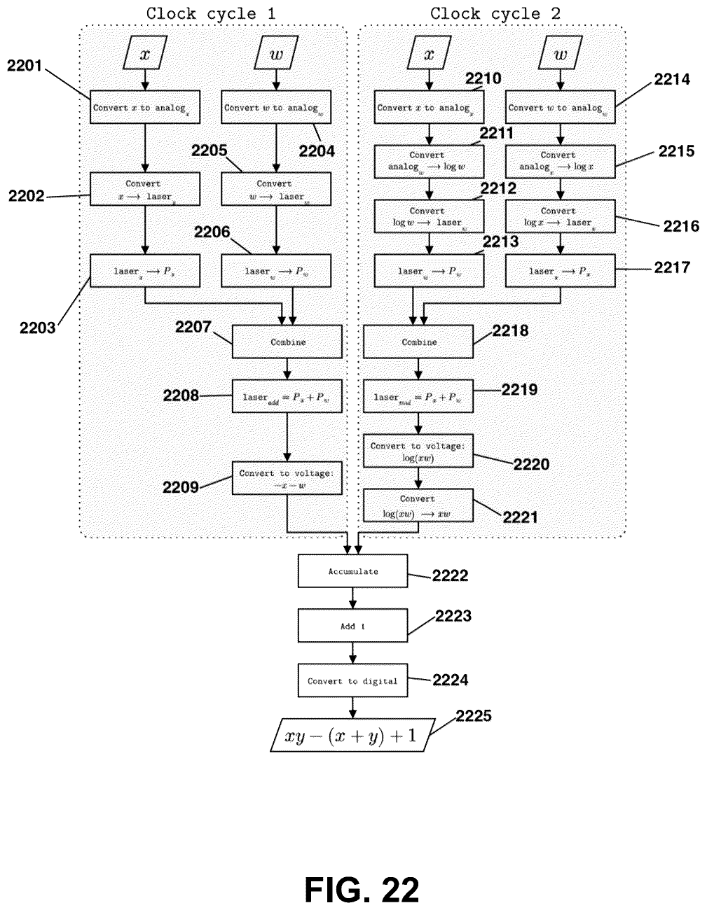

In another embodiment shown in FIG. 22 & FIG. 23, the operations specific to the signed multiplication are performed using only one set of components across two clock cycles, leveraging the integration circuit 2316 to perform both the subtraction and addition (as discussed for FIG. 20 & FIG. 21. FIG. 22 shows a flow diagram of the operations of the present disclosure following this approach and FIG. 23 shows the component implementation of the present disclosure following this approach. In this embodiment, the steps shown in FIG. 22 are similar to those of FIG. 20. In addition to these steps 2201 to 2209, the steps 2210 to 2221 are added, including digital-to-analog converters 2302 & 2309, modulators 2306 & 2313 and lasers 2307 & 2314 representing the values of the input tensors, an optical combiner and converter 2315 to yield the addition of the two input tensor values, multiplied by a negative sign. In other aspects, the steps 2201 to 2209 of FIG. 22 are similar to those described in FIG. 9, FIG. 11, FIG. 13 and FIG. 16. Linear amplifiers 2303 & 2310 are added to the implementation in FIG. 12, in parallel to the logarithmic amplifiers 2304 & 2311. A two-state selector switch 2305 & 2312 or other component of similar functionality is used to connect the modulators with either the linear 2303, 2310 or logarithmic amplifiers 2304, 2311. The branches 2305 & 2312 connected to the modulators 2306 & 2313 are selected according to the chosen mode of operation, as shown in FIG. 23. Analogously, a linear amplifier 2317 is added in parallel to the exponential amplifier 2316, and a selector switch 2317 to connect the output of only one of the amplifiers to the integrator 2316, as shown in FIG. 23. In this embodiment, the implementation operates according to a chosen configuration, or mode. In one mode, which we refer to as “multiplication mode” the selector switches connect the logarithmic amplifiers 2304 & 2311 to the modulators 2306 & 2313 and the exponential amplifier 2316 to the integrator. In another mode, which we refer to as “addition mode”, the switches connect the linear amplifiers 2303 & 2310 to the modulators 2306 & 2313 and the linear amplifier 2317 to the integrator 2316. In multiplication mode the integrator accumulates the product of the input tensor values. In addition, mode the integrator accumulates the negative addition of the input tensor values. As such, performing the operations of the two modes in successive clock cycles with the same inputs, together with the accumulation of a constant offset, is used to yield the signed multiplication result.

Other embodiments of the methods and implementations described above may employ different conventions for performing the multiplication of signed values, resulting in different ranges for signed and unsigned values and additional scaling factors.

6. Tensor Multiplication with High Output Precision

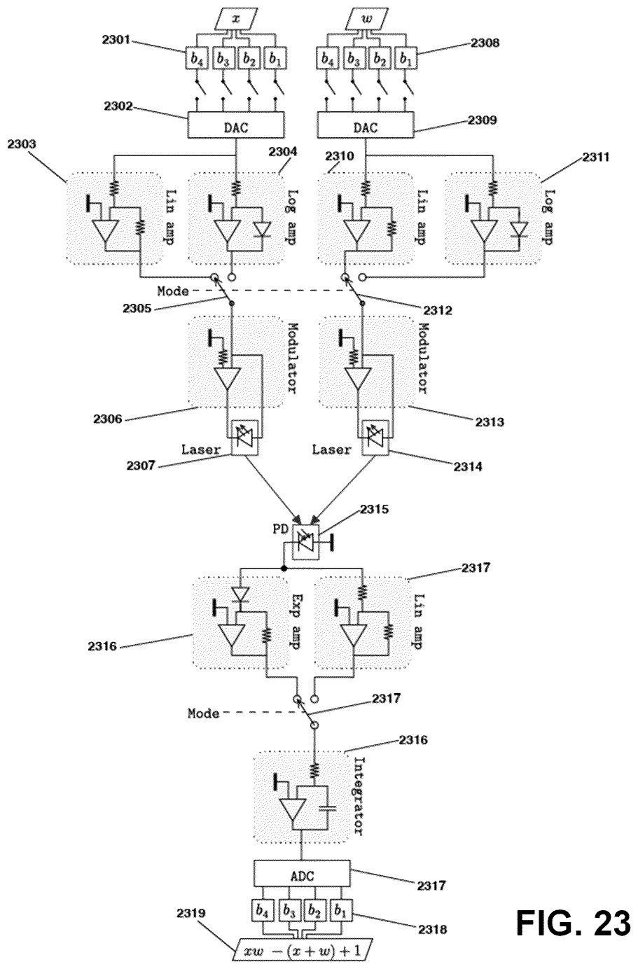

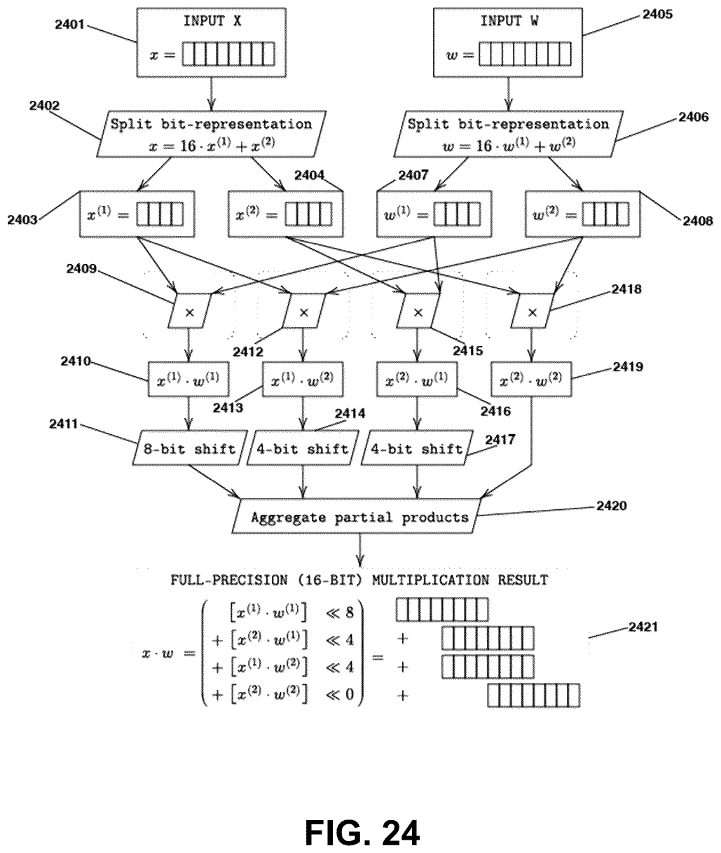

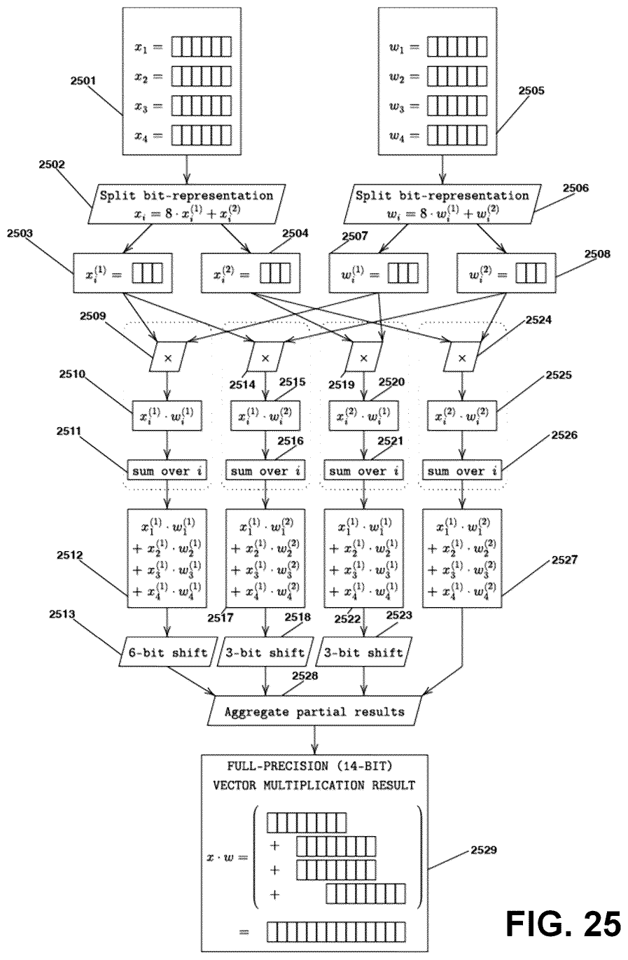

The following alternative embodiments shown in FIG. 24 and FIG. 25 provide two approaches and implementations for adding further precision to tensor multiplications performed according to one embodiment of the present disclosure.

Tensor multiplication on an analog device produces imprecision due to the limited readout resolution and finite signal-to-noise ratio of analog signals. For example, an exact multiplication of two positive 8-bit integers yields a 16-bit result. However, it is possible that noise may make, for example, the first 8 bits of the 16 bits reliable (the least significant bits having a large probability of being incorrect) and second 8 bits unreliable. Using inputs with larger intervals (e.g. only 4 bits of effective precision) reduces the number of bits in the multiplication output and also reduces the probability for errors occurring.

The Karatsuba algorithm is a well-known algorithm used for obtaining a larger number of precision bits for a multiplication of two values, even if the multiplier hardware cannot accommodate the precision bits.

See https://www.researchgate.net/publication/234346907_Multiplication_of_Multidigit_Number s_on_Automata, see also https://en.wikipedia.org/wiki/Karatsuba_algorithm.

Referring to FIG. 24, 8-bit integer values are split into two 4-bit representations or words for each of the input values. Then a series of partial multiplications are performed and the results are accumulated into a larger output.

Each of the boxes 2409, 2412, 2415 & 2418 shown with an X in FIG. 24 denotes a tensor multiplication operation. Each tensor multiplication may be implemented by the embodiments of the present disclosure discussed herein. For example, for the vector-vector multiplication as shown in FIG. 11 and FIG. 12 each of the four multiplications 2409, 2412, 2415 & 2418 denoted X is performed by the steps and the components as discussed with reference to these figures. Likewise, this approach to multiplication may be applied to the operations and components for vector-matrix and matrix-matrix multiplication according to embodiments of the present disclosure as well.

Referring to FIG. 25, another embodiment for performing precision multiplication is discussed. By summing positive integers, the effective bit width is increased providing for more exact results. When a sum is performed between the partial products and the aggregation, this means that lower-resolution vector inputs must be used to obtain an exact vector-vector analog product. An implementation for two vectors of four elements e.g. X1, X2, X3, and X4, & W1, W2, W3, and W4, where each value contains 6 bits, has an exact result representation with 14 bits. This can be obtained using the process in FIG. 25, where the multiplication units 2509, 2514, 2519 & 2524 denoted by X are the system and methods of the present disclosure described herein for vector-vector, vector-matrix and matrix-matrix multiplication and where the readout accuracy is 8 bits.

Various circuit structures for photonic processors are described herein with respect to various embodiments of the present disclosure. These circuit structures may be represented using digital information that may be stored on a non-transitory computer-readable medium, such as flash memory (e.g., a solid-state drive), a hard disk drive, and the like. These digital representations may include, for example, embodiments of the present disclosure described in a hardware description language (HDL) such as Verilog and VHDL, analog circuit models described as, for example, SPICE (Simulation Program with Integrated Circuit Emphasis) models, and the like, and in various forms suitable for integration a module or sub-circuit of an integrated circuit design. The digital representations may also include, for example, files representing designs of integrated circuits (ICs), such as GDSII stream format (GDSII) files suitable for being supplied to a foundry for fabrication of an integrated circuit implementing photonic processors according to embodiments of the present disclosure.

According to one embodiment, an optical processing unit for performing tensor multiplication on a value of a first tensor and a value of a second tensor, includes: a first converter configured to convert the value of the first tensor into a first analog signal, a first logarithmic amplifier to convert the first analog signal into a second analog signal that represents the log of the value of the first tensor, a first modulator and a first light source to convert the second analog signal into a first light beam, a second converter configured to convert the value of the second tensor into a third analog signal, a second logarithmic amplifier to convert the third analog signal into a fourth analog signal that represents the log of the value of the second tensor, a second modulator and a second light source to convert the fourth analog signal into a second light beam, and an optical combiner to add the first light beam with the second light beam to obtain a resulting light beam representing the log of the value of the first tensor multiplied by the value of the second tensor or the log of the value of the first tensor added to the log of the value of the second tensor.

The optical processing unit may further include a transducer to convert the resulting light beam into a fifth analog signal.

The transducer may include a photodiode.

The optical processing unit may further include an antilogarithmic amplifier for converting the fifth analog signal into a sixth analog signal that represents the antilog or exponential of the fifth analog signal.

The optical processing unit may further include a third converter configured to take the sixth analog signal and convert it into a digital signal.

The first light source and the second light source may respectively include a first vertical-cavity surface-emitting laser (VCSEL) and a second VCSEL.

The first tensor and the second tensor may respectively include a first vector and a second vector, wherein the optical processing unit performs vector-vector multiplication.

The first tensor may include a vector and the second tensor may include a matrix for performing vector-matrix multiplication.

The first tensor may include a matrix and the second tensor may include a matrix for performing matrix-matrix multiplication.

The first light beam or the second light beam may be fanned out by one or more diffractive elements to provide a plurality of light beams.

The first light beam and the second light beam may be fanned out by one or more diffractive elements to provide a plurality of light beams.

The one or more diffractive elements may be transmissive and located vertically between the light sources and one or more photodiodes to convert the plurality of light beams into analog signals.

The diffractive elements may be reflective and the first light source and the second light source may be located on a same substrate as one or more photodiodes to convert the plurality of light beams into analog signals.

The optical processing unit may further include: a) a first linear amplifier and a second linear amplifier to convert the first analog signal and the third analog signal into a seventh analog signal and an eighth analog signal that represent the values of the first tensor and the second tensor, and b) a third modulator and a fourth modulator and a third light source rand a fourth light source to convert the seventh analog signal and the eighth analog signal into a third light beam and a fourth light beam.

The optical processing unit may further include: a third modulator and a fourth modulator and a third light source and a fourth light source to convert the seventh analog signal and the eighth analog signal into a third light beam and a fourth light beam.

The optical processing unit may further include a second optical combiner to add the third light beam with the fourth light beam to obtain a second resulting light beam representing the value of the first tensor added to the value of the second tensor.

The optical processing unit may further include a second transducer to convert the second resulting light beam into a ninth analog signal that represents value of the first tensor added to the value of the second tensor.

The second transducer may be a photodiode.

The optical processing unit may further include a) a third linear amplifier to convert the ninth analog signal into a tenth analog signal, b) a subtractor to take the difference between the sixth analog signal and the tenth analog signal to obtain an eleventh analog signal, and c) an analog to digital converter to convert the eleventh analog signal into a digital signal.

The optical processing unit may further include an analog to digital converter to convert the eleventh analog signal into a digital signal.

The optical processing unit may further include a subtractor to take the difference between the sixth analog signal and the tenth analog signal and add the integer value 1 to obtain an eleventh analog signal.

The optical processing unit for performing tensor-tensor multiplication wherein the value of the first tensor and the second tensor may each be represented by a plurality of bits and the first tensor bit representation and the second tensor bit representation may each be further split into at least two or more words.

The optical processing unit may further include at least one adder for aggregating the at least two or more partial products into a resulting multiplication product.

According to one embodiment of the present disclosure, a method of optically performing tensor multiplication on a value of a first tensor and a value of a second tensor includes: converting the value of the first tensor into a first analog signal, processing the first analog signal through a first logarithmic amplifier to obtain a second analog signal that represents the log of the value of the first tensor, modulating a first light source with the second analog signal to produce a first light beam, converting the value of the second tensor into a third analog signal, processing the third analog signal through a second logarithmic amplifier to obtain a fourth analog signal representing the log of the value of the second matrix, modulating a second light source with the fourth analog signal to produce a second light beam, and optically combining the first light beam and the second light beam to obtain a resulting light beam representing the log of the value of the first tensor multiplied by the value of the second tensor or the log of the value of the first tensor added to the log of the value of the second tensor.

The method may further include the step of using a transducer to convert the resulting light beam into a fifth analog signal.

The transducer may include a photodiode.

The method may further include the step of converting the fifth analog signal into a sixth analog signal that represents the antilog of the fifth analog signal.

The step for converting the fifth analog signal into a sixth signal may include using an antilogarithmic amplifier.

The steps for modulating first light source and second light source may include the steps of modulating first and second vertical-cavity surface-emitting lasers (VCSEL).

The first tensor and second tensor for performing tensor-tensor multiplication respectively may include a first vector and a second vector for performing vector-vector multiplication.

The first tensor and the second tensor for performing tensor-tensor multiplication may respectively include a vector and a matrix for performing vector-matrix multiplication.

The first tensor and the second tensor for performing tensor-tensor multiplication respectively may include a first matrix and a second matrix for performing matrix-matrix multiplication.

The steps for producing the first light beam or second light beam may further include the step of fanning out by one or more diffractive elements to provide a plurality of light beams.

The steps for producing the first light beam and the second light beams may further include the step of fanning out by one or more diffractive elements to provide a plurality of light beams.

The method may further include the steps: a) converting the first analog signal and the third analog signal using a first linear amplifier and a second linear amplifier into a seventh analog signal and an eighth analog signal that respectively represent the values of the first tensor and the second tensor, and b) converting the seventh analog signal and the eighth analog signal into, respectively, a third light beam and a fourth light beam respectively using a third modulator and a fourth modulators and a third light beam and a fourth light beam.

The method may further include the step of converting the seventh analog signal and the eighth analog signal into a third light beam and a fourth light beam using a third modulator and a fourth modulator and a third light source and a fourth light source.

The method may further include the step of adding the third light beam with the fourth light beam to obtain a second resulting light beam representing the value of the first tensor added to the value of the second tensor by using a second optical combiner.

The method may further include the step of using a second transducer to convert the light beam into a ninth analog signal that represents value of the first tensor added to the value of the second tensor.

The transducer may be a photodiode.

The method may further include the steps of: a) using a third linear amplifier to convert the ninth analog signal into a tenth analog signal, b) using a subtractor to take the difference between the sixth analog signal and the tenth analog signal and add a positive constant value to obtain an eleventh analog signal, and c) using an analog to digital converter to convert the eleventh analog signal into a digital signal.

The method may further include the steps: a) using a subtractor to take the difference between the sixth analog signal and the tenth analog signal and add the integer value 1 to obtain an eleventh analog signal, and b) using an analog to digital converter to convert the eleventh analog signal into a digital signal.

The method for performing tensor-tensor multiplication wherein the value of the first tensor and the second tensor may each represented by a plurality of bits and the first tensor bit representation and second tensor bit representation may each be further split into at least two or more words.

The method may further include the steps of using at least one adder for aggregating the at least two or more partial products into a resulting multiplication product.

Aspects of embodiments of the present disclosure have been described in various embodiments, but are not limited thereto. For example, any of the components of the disclosure, including those discussed in the glossary, can be implemented as separate components on a motherboard, embedded in a silicon chip and/or in firmware. Additionally, steps performed in possible embodiments in more than one clock cycle may be performed in parallel operations in fewer clock cycles, including a single clock cycle, by adding additional and duplicative components to possible embodiments. Adding clock cycles to the operation of the possible embodiments enables fewer components to be used. Those skilled in the art will recognize that a number of additional modifications and improvements can be made to the disclosure without departure from the essential spirit and scope.

According to one embodiment of the present disclosure, an optical processing unit for performing tensor multiplication on a value of a first tensor and a value of a second tensor includes: a first converter configured to convert the value of the first tensor into a first analog signal, a first logarithmic amplifier to convert the first analog signal into a second analog signal that represents the log of the value of the first tensor, a first modulator and a first light source to convert the second analog signal into a first light beam, a second converter configured to convert the value of the second tensor into a third analog signal, a second logarithmic amplifier to convert the third analog signal into a fourth analog signal that represents the log of the value of the second tensor, a second modulator and a second light source to convert the fourth analog signal into a second light beam, and an optical combiner to add the first light beam with the second light beam to obtain a resulting light beam representing the log of the value of the first tensor multiplied by the value of the second tensor or the log of the value of the first tensor added to the log of the value of the second tensor, a transducer to convert the resulting light beam into a fifth analog signal, an antilogarithmic amplifier for converting the fifth analog signal into a sixth analog signal that represents the antilog or exponential of the fifth analog signal. With respect to FIG. 10, a slightly modified circuit design for reducing power

consumption and increasing speed is discussed. To summarize the circuit and its operation in FIG. 10, the DAC 1002 (and respectively 1007), the logarithmic amplifier 1003 (and respectively 1008), the modulator 1004 (and respectively 1009) and the laser 1005 (and respectively 1010) form a first unit, i.e., 1002, 1003, 1004, and 1005 (and respectively a second unit i.e., 1007, 1008, 1009 and 1010) which is arranged to receive a value of a first tensor 1001 (and respectively a second tensor 1006) and to output a first light beam (and respectively a second light beam).

Photodiode 1011 receives the first and second light beams and optically combines them into an analog signal which is provided to the antilogarithmic amplifier 1012 whose output is then converted into a digital signal at ADC 1013. The photodiode 1011, the antilogarithmic amplifier 1012 and the ADC 1013 form a third unit for providing a result signal from the combination of light beams.

It will be apparent that the same unit descriptions could also be applied to the embodiments of FIGS. 12, 14; 17, 21 and 23.

While the embodiments of FIGS. 10, 12, 14; 17, 21 and 23 comprise a first unit and a second unit in which the tensor value is converted to an analog signal with the logarithmic amplifier being analog, it is apparent to the person skilled in the art that the DACs in the first unit could be provided downstream of the logarithmic amplifiers (e.g., FIG. 10, 1003, 1008) and before the modulators (e.g., FIG. 10, 1004, 1009). The logarithmic amplifier would then be digital (e.g., implemented in software or firmware with a lookup table). More precisely, the tensor value would be provided digitally to a digital logarithmic amplifier which output would be converted to an analog signal by the DAC prior to conversion into a light beam by the modulator and the laser.

This approach would reduce the circuit need for an analog component, the analog logarithmic amplifier, by replacing it with a digital logarithmic amplifier which will reduce the power consumption and increase the speed of the circuit.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C. A person of ordinary skill in the art would appreciate, in view of the present

disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

Glossary

Linear Amplifier (FIG. 26): A linear amplifier is a type of inverting amplifier that uses a resistor on the inverting terminal and one on the feedback loop to produce an output proportional to the input but at a higher power. The equation that represents this can be represented below, where V₁ is the circuit's input voltage, where V₀ is the output voltage, R_{f} is resistance on the feedback loop, R₁ is resistance on the inverting terminal, and Iₛ is the saturation current.

Exponential Amplifier (FIG. 27): An exponential amplifier is a type of inverting amplifier that uses a diode on the inverting terminal to produce an output proportional to the exponential of the diode input. The equation that represents this can be represented below, where V₁ is the circuit's input voltage, where VT is the diode's thermal equivalent voltage, R_{f} is resistance and Iₛ is the saturation current.

Log Amplifier (FIG. 28): A Logarithmic Amplifier is a type of inverting amplifier in which the feedback loop is not regulated by a resistor but replaced by a diode; the output is proportional to the natural logarithm of the input. The equation that can be represented below is V₁ is the input voltage, Iₛ is the saturation current, R₁ is the resistance connected to the inverting terminal, VT is the diode's thermal equivalent voltage and n is the ideality parameter of the diode.

Integrator (FIG. 29): An integration circuit is a type of inverting amplifier in which the feedback loop is not regulated by a resistor but replaced by a capacitor. This capacitor accumulates the charges of the resistor connected to the inverting terminal of the amplifier and acts like a time integrator. The output is then equal to the time integral of the input voltage times the frequency of the RC circuit. The equation can be represented below where Vₜ is the voltage input, tis time, R is the resistance, and C is the capacitance.

Voltage Adder Amplifier (FIG. 38): A voltage adder amplifier circuit is a type of inverting amplifier that has two input resistors connected to the inverting terminal while the non-inverting terminal is grounded. The feedback path is connected to a resistor. The equation that can be represented below, where V1 and V2 are the circuit's input voltages, R is the resistance on the input (assuming R1=R2) and Rf is the feedback loop resistance.

VCSEL: A vertical-cavity surface-emitting laser are semiconductor lasers, more specifically laser diodes with a monolithic laser resonator, where the emitted light leaves the device in a direction perpendicular to the chip surface (https://www.rp-photonics.com/vertical_cavity_surface_emitting_lasers.html). For instance, a nonlimiting set of examples of light sources that could be used are as follows: Photonic-Crystal surface-emitting lasers (PCSEL), Distributed feedback/Edge Emitting lasers, light-emitting Diodes and others.

Additionally other light sources could be used such as LEDs and others.

What is claimed is:

1. An optical processing unit for performing tensor multiplication on a value of a first tensor and a value of a second tensor, the optical processing unit comprising:
a first unit arranged to emit a first light beam based on said value of a first tensor, said first unit comprising a first logarithmic amplifier arranged to produce a first unit electric signal that represents the log of said value of the first tensor, and a first modulator and a first light source arranged to emit said first light beam based on said first unit electric signal;
a second unit arranged to emit a second light beam based on said value of a second tensor, said second unit comprising a second logarithmic amplifier arranged to produce a second unit electric signal that represents the log of said value of the second tensor, and a second modulator and a second light source arranged to emit said second light beam based on said second unit electric signal;
an optical combiner to add the first light beam with the second light beam to obtain a resulting light beam representing the log of the value of the first tensor multiplied by the value of the second tensor or the log of the value of the first tensor added to the log of the value of the second tensor; and
a third unit comprising a transducer to convert said resulting light beam into a resulting electric signal, and an antilogarithmic amplifier arranged to determine a result signal representing the antilog or exponential of said resulting electric signal.

2. The optical unit of claim 1, wherein said first logarithmic amplifier is configured to receive said value of a first tensor as an input and to return said first unit electric signal as a first digital signal, said first unit further comprising a first converter configured to convert said first digital signal into a first analog signal which is provided as the input to said first modulator.

3. The optical unit of claim 2, wherein said second logarithmic amplifier is configured to receive said value of a second tensor as an input and to return said second unit electric signal as a second digital signal, said second unit further comprising a second converter configured to convert said second digital signal into a second analog signal which is provided as the input to said second modulator.

4. The optical unit of claim 1, wherein said second logarithmic amplifier is configured to receive said value of a second tensor as an input and to return said second unit electric signal as a second digital signal, said second unit further comprising a second converter configured to convert said second digital signal into a second analog signal which is provided as the input to said second modulator.

5. The optical unit of claim 1, wherein said first unit comprises a first converter configured to convert the value of the first tensor into a first analog signal which is provided as an input to said first logarithmic amplifier which outputs said first unit electric signal as an analog signal which is provided as the input to said first modulator.

6. The optical unit of claim 5, wherein said second unit comprises a second converter configured to convert the value of the second tensor into a second analog signal which is provided as an input to said second logarithmic amplifier which outputs said second unit electric signal as an analog signal which is provided as the input to said second modulator.

7. The optical processing unit of claim 6 further comprising:
a) a first linear amplifier and a second linear amplifier to convert the first analog signal and the second analog signal into a seventh analog signal and an eighth analog signal that represent the values of the first tensor and the second tensor, and
b) a third modulator and a fourth modulator and a third light source and a fourth light source to convert the seventh analog signal and the eighth analog signal into a third light beam and a fourth light beam.

8. The optical processing unit of claim 1, wherein said resulting electric signal is an analog signal provided as input to antilogarithmic amplifier, the output of which is an analog signal, the third unit further comprising a third converter configured to take the analog signal output of said antilogarithmic amplifier and to convert it into a digital signal which forms said result signal.

9. The optical processing unit of claim 1, wherein the first light source and the second light source respectively comprise a first vertical-cavity surface-emitting laser (VCSEL) and a second VCSEL.

10. The optical processing unit of claim 1, wherein the first light beam and/or the second light beam is fanned out by one or more diffractive elements to provide a plurality of light beams.

11. The optical processing unit of claim 10, wherein the one or more diffractive elements are transmissive and located vertically between the first and second light sources and one or more photodiodes to convert the plurality of light beams into analog signals.

12. The optical processing unit of claim 10, wherein the one or more diffractive elements are reflective and the first light source and the second light source are located on a same substrate as one or more photodiodes to convert the plurality of light beams into analog signals.

13. A method for optically performing tensor multiplication on a value of a first tensor and a value of a second tensor using an optical processing unit, the method comprising:
controlling a first unit to emit a first light beam based on said value of a first tensor, said first unit comprising a first logarithmic amplifier arranged to produce a first unit electric signal that represents the log of said value of the first tensor, and a first modulator and a first light source arranged to emit said first light beam based on said first unit electric signal;
controlling a second unit to emit a second light beam based on said value of a second tensor, said second unit comprising a second logarithmic amplifier arranged to produce a second unit electric signal that represents the log of said value of the second tensor, and a second modulator and a second light source arranged to emit said second light beam based on said second unit electric signal;
adding the first light beam with the second light beam using an optical combiner to obtain a resulting light beam representing the log of the value of the first tensor multiplied by the value of the second tensor or the log of the value of the first tensor added to the log of the value of the second tensor; and
converting said resulting light beam into a resulting electric signal using a transducer; and
generating, by an antilogarithmic amplifier, a result signal representing the antilog or exponential of said resulting electric signal.

14. The method of claim 13, wherein said first logarithmic amplifier is configured to receive said value of a first tensor as an input and to return said first unit electric signal as a first digital signal, said first unit further comprising a first converter configured to convert said first digital signal into a first analog signal which is provided as the input to said first modulator.

15. The method of claim 14, wherein said second logarithmic amplifier is configured to receive said value of a second tensor as an input and to return said second unit electric signal as a second digital signal, said second unit further comprising a second converter configured to convert said second digital signal into a second analog signal which is provided as the input to said second modulator.

16. The method of claim 13, wherein said second logarithmic amplifier is configured to receive said value of a second tensor as an input and to return said second unit electric signal as a second digital signal, said second unit further comprising a second converter configured to convert said second digital signal into a second analog signal which is provided as the input to said second modulator.

17. The method of claim 13, wherein said first unit comprises a first converter configured to convert the value of the first tensor into a first analog signal which is provided as an input to said first logarithmic amplifier which outputs said first unit electric signal as an analog signal which is provided as the input to said first modulator.

18. The method of claim 17, wherein said second unit comprises a second converter configured to convert the value of the second tensor into a second analog signal which is provided as an input to said second logarithmic amplifier which outputs said second unit electric signal as an analog signal which is provided as the input to said second modulator.

19. The method of claim 18, wherein the optical processing unit further comprises:
a) a first linear amplifier and a second linear amplifier to convert the first analog signal and the second analog signal into a seventh analog signal and an eighth analog signal that represent the values of the first tensor and the second tensor, and
b) a third modulator and a fourth modulator and a third light source and a fourth light source to convert the seventh analog signal and the eighth analog signal into a third light beam and a fourth light beam.

20. The method of claim 13, wherein said resulting electric signal is an analog signal provided as input to antilogarithmic amplifier, the output of which is an analog signal, and
wherein the optical processing unit comprises a third unit comprising:
the transducer;
the antilogarithmic amplifier; and
a third converter configured to take the analog signal output of said antilogarithmic amplifier and to convert it into a digital signal which forms said result signal.

21. The method of claim 13, wherein the first light source and the second light source respectively comprise a first vertical-cavity surface-emitting laser (VCSEL) and a second VCSEL.

22. The method of claim 13, wherein the first light beam and/or the second light beam is fanned out by one or more diffractive elements to provide a plurality of light beams.

23. The method of claim 22, wherein the one or more diffractive elements are transmissive and located vertically between the first and second light sources and one or more photodiodes to convert the plurality of light beams into analog signals.

24. The method of claim 22, wherein the one or more diffractive elements are reflective and the first light source and the second light source are located on a same substrate as one or more photodiodes to convert the plurality of light beams into analog signals.
